(19) United States
(12) Patent Application Publication
(10) Pub. No.: US 2023/0401501 A1
(43) Pub. Date: Dec. 14, 2023

(54) Determination of Insights for Construction Projects

(71) Applicant: Procore Technologies, Inc., Carpinteria, CA (US)

(72) Inventors: James Adam Pita, Middletown, MD (US); Catherine Knuff, Brooklyn, NY (US); Joshua Alexander Newland, Walnut Creek, CA (US); Gagik Hacobian, La Crescenta, CA (US); Abigail Catherine Hoffman, Austin, TX (US); Ripple Priya Goyal, San Jose, CA (US); Daniel Luther Pierre, Scarborough (CA)

(21) Appl. No.: 17/835,575

(22) Filed: Jun. 8, 2022

(51) Int. Cl. G06Q 10/06; G06Q 50/08

(52) U.S. Cl. CPC G06Q 10/06313; G06Q 50/08

(57) ABSTRACT

A computing platform is configured to: for each construction project in a pool of construction projects, (i) obtain a set of data objects related to the construction project; (ii) evaluate the obtained set of data objects related to the construction project and thereby identify two or more theme-specific subsets of data objects, wherein each respective theme-specific subset of data objects corresponds to a respective one of two or more construction-related themes; (iii) for each respective one of the two or more construction-related themes, evaluate the respective theme-specific subset of data objects and thereby identify a respective theme-specific group of one or more construction-related problems that correspond to the respective one of two or more construction-related themes; and (iv) based at least on the theme-specific groups of one or more construction-related problems that respectively correspond to the two or more construction-related themes, generate a project-specific themes dataset for the construction project.

### BACKGROUND

Construction projects are often complex endeavors involving the coordination of many professionals across several discrete phases. Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as HVAC, plumbing, electrical, etc., and produce plans reflecting these designs as well. After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction phase, construction professionals begin to construct the project based on the finalized plans.

### OVERVIEW

Throughout a construction project, there may be high-level construction-related problems or issues that may affect the progress and/or outcome of a construction project as a whole. Various high-level construction-related problems are possible, examples of which include a cost problem (e.g., budget overrun) related to the construction project, a scheduling problem (e.g., schedule overrun) related to the construction project, a quality problem related to the construction project, and/or a safety problem related to the construction project, among other possibilities. Such construction-related problems may lead to undesirable outcomes for the construction project, such as a budget issue, a schedule issue, a quality issue, and/or a safety issue. It would be desirable to be able to recognize that these problems may be likely to occur on a construction project before they happen, so that the problems can be avoided or at least minimized during a construction project.

One way to attempt to recognize which construction-related problems may be likely to occur on a construction project before they happen is by evaluating historical data about prior construction projects. Historical data about prior construction projects may take various forms. In general, historical data may be any data created and stored throughout a construction project, such as data created and stored during a design phase, a planning phase, a logistics phase, and/or a construction phase of a construction project, among other possibilities. In some cases, historical data may include data objects related to construction projects that are created, stored, and accessed by users of a software as a service (“SaaS”) application for construction management. Numerous types of data objects related to construction projects are possible, examples of which include data objects related to incidents (such as quality and/or safety incidents) that occurred during construction projects, data objects related to scheduling for construction projects, data objects related to inspections during construction projects, various types of financial-related data objects such data objects related to budget items for construction projects, and/or data objects related to requested information about given project tasks, among other possibilities.

However, attempting to derive insights about forthcoming construction-related problems that may be likely to occur on a construction project from historical data such as this can present numerous problems. For example, historical data may take the form of various different types of data objects (which may comprise a mix of structured and unstructured data) and the historical data may not be well organized. Such a mix of data and such organization may make it difficult to evaluate the historical data and derive insights about forthcoming construction-related problems. Further, the data may be voluminous, which may also make it difficult to evaluate the historical data and derive insights about forthcoming construction-related problems. In this regard, not only may there be a large number of completed or ongoing construction projects to be evaluated, but there may also be, for any given construction project, a large number of historical data objects (which may be on the order of tens of thousands, hundreds of thousands, millions, etc.). These factors (among others) make it difficult to extract meaningful insights regarding forthcoming problems from such historical data.

To help address the aforementioned and other problems, disclosed herein is new software technology for generation of themes data for completed or ongoing construction projects and determination of one or more insights related to a new or ongoing construction project based on the themes data. In practice, the disclosed software technology could be implemented in SaaS application for construction management, such as the SaaS application offered by Procore Technologies, Inc., but it should be understood that the disclosed technology for generation of themes data for completed or ongoing construction projects and determination of one or more insights related to a new or ongoing construction project based on the themes data may be incorporated into various other types of software applications as well (including software applications in industries other than construction).

In accordance with the disclosed technology, a computing platform is configured to generate themes data for completed or ongoing construction projects. The computing platform may generate themes data for completed or ongoing construction projects in various ways.

As one possibility, the computing platform may be configured to, for each respective construction project in a pool of construction projects: (i) obtain a set of data objects related to the respective construction project; (ii) evaluate the obtained set of data objects related to the respective construction project and thereby identify two or more problem-specific subsets of data objects, wherein each respective problem-specific subset of data objects corresponds to a respective one of two or more construction-related problems; (iii) for each respective one of the two or more construction-related problems, evaluate the respective problem-specific subset of data objects and thereby identify a respective problem-specific group of one or more construction-related themes that correspond to the respective one of two or more construction-related problems; and (iv) based at least on the problem-specific groups of one or more construction-related themes that respectively correspond to the two or more construction-related problems, generate a project-specific themes dataset for the respective construction project.

As another possibility, the computing platform may be configured to, for each respective construction project in a pool of construction projects: (i) obtain a set of data objects related to the respective construction project; (ii) evaluate the obtained set of data objects related to the respective construction project and thereby identify two or more theme-specific subsets of data objects, wherein each respective theme-specific subset of data objects corresponds to a respective one of two or more construction-related themes; (iii) for each respective one of the two or more construction-related themes, evaluate the respective theme-specific subset of data objects and thereby identify a respective theme-specific group of one or more construction-related problems that correspond to the respective one of two or more construction-related themes; and (iv) based at least on the theme-specific groups of one or more construction-related problems that respectively correspond to the two or more construction-related themes, generate a project-specific themes dataset for the respective construction project.

Further, the computing platform is configured to, after generating the project-specific themes datasets for the pool of construction project, determine one or more insights related to a new or ongoing construction project based on the generated themes data. For instance, the computing platform may be configured to, after generating the project-specific themes datasets for the pool of construction projects: (i) receive information about a given construction project; (ii) based at least on the received information about the given construction project, identify, from the pool of construction projects, a given set of construction projects having a threshold level of similarity to the given construction project; (iii) for each respective construction project in the given set of construction projects, obtain the project-specific themes dataset for the respective construction project; (iv) based on the project-specific themes datasets that are obtained for the given set of construction projects, determine one or more insights related to the given construction project; and (v) transmit, to a client station, data defining the one or more insights and thereby cause an indication of the one or more insights to be presented at a user interface of the client station.

The software technology disclosed herein may provide various benefits over existing techniques for recognizing which construction-related problems may be likely to occur on a construction project before they happen. For instance, generating themes data for completed or ongoing construction projects and determining one or more insights related to a new or ongoing construction project based on the generated themes data may provide a more efficient and accurate way to derive insights about likely forthcoming construction-related problems compared to existing approaches for deriving insights about likely forthcoming construction-related problems. Further, by organizing historical data based on themes data for completed or ongoing construction projects, the disclosed technology can provide meaningful insights regarding high-level themes (which may also be referred to herein as “topics”) that may underlie and/or otherwise be associated with construction-related problems that commonly occur on construction projects. For a given new or ongoing construction project, themes data for a given set of construction projects having a threshold level of similarity to the given new or ongoing construction project may be aggregated, and this aggregated themes data may provide an indication of which one or more themes (and/or underlying issues) may be likely to be most impactful for each problem that may arise on the new or ongoing construction project.

In accordance with the above, in one aspect, disclosed herein is a method that involves a computing platform: (a) for each respective construction project in a pool of construction projects: (i) obtaining a set of data objects related to the respective construction project; (ii) evaluating the obtained set of data objects related to the respective construction project and thereby identifying two or more problem-specific subsets of data objects, wherein each respective problem-specific subset of data objects corresponds to a respective one of two or more construction-related problems; (iii) for each respective one of the two or more construction-related problems, evaluating the respective problem-specific subset of data objects and thereby identifying a respective problem-specific group of one or more construction-related themes that correspond to the respective one of two or more construction-related problems; and (iv) based at least on the problem-specific groups of one or more construction-related themes that respectively correspond to the two or more construction-related problems, generating a project-specific themes dataset for the respective construction project; and (b) after generating the project-specific themes datasets for the pool of construction projects: (i) receiving information about a given construction project; (ii) based at least on the received information about the given construction project, identifying, from the pool of construction projects, a given set of construction projects having a threshold level of similarity to the given construction project; (iii) for each respective construction project in the given set of construction projects, obtaining the project-specific themes dataset for the respective construction project; (iv) based on the project-specific themes datasets that are obtained for the given set of construction projects, determining one or more insights related to the given construction project; and (v) transmitting, to a client station, data defining the one or more insights and thereby causing an indication of the one or more insights to be presented at a user interface of the client station.

In another aspect, disclosed herein is a computing system that includes at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium comprising program instructions that are executable to cause a computing platform to carry out the functions disclosed herein, including but not limited to the functions of the foregoing method.

In still yet another aspect, disclosed herein is a method that involves a computing platform: (a) for each respective construction project in a pool of construction projects: (i) obtaining a set of data objects related to the respective construction project; (ii) evaluating the obtained set of data objects related to the respective construction project and thereby identifying two or more theme-specific subsets of data objects, wherein each respective theme-specific subset of data objects corresponds to a respective one of two or more construction-related themes; (iii) for each respective one of the two or more construction-related themes, evaluating the respective theme-specific subset of data objects and thereby identifying a respective theme-specific group of one or more construction-related problems that correspond to the respective one of two or more construction-related themes; and (iv) based at least on the theme-specific groups of one or more construction-related problems that respectively correspond to the two or more construction-related themes, generating a project-specific themes dataset for the respective construction project; and (b) after generating the project-specific themes datasets for the pool of construction projects: (i) receiving information about a given construction project; (ii) based at least on the received information about the given construction project, identifying, from the pool of construction projects, a given set of construction projects having a threshold level of similarity to the given construction project; (iii) for each respective construction project in the given set of construction projects, obtaining the project-specific themes dataset for the respective construction project; (iv) based on the project-specific themes datasets that are obtained for the given set of construction projects, determining one or more insights related to the given construction project; and (v) transmitting, to a client station, data defining the one or more insights and thereby causing an indication of the one or more insights to be presented at a user interface of the client station.

In still yet another aspect, disclosed herein is a computing system that includes at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

In still yet another aspect, disclosed herein is a non-transitory computer-readable medium comprising program instructions that are executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions according to the disclosed technology.

FIG. 3A depicts an example process for generation of themes data for completed or ongoing construction projects according to the disclosed technology.

FIG. 3B depicts an example process for generation of themes data for completed or ongoing construction projects according to the disclosed technology.

FIG. 3C depicts an example process for determination of one or more insights related to a new or ongoing construction project based on themes data for completed or ongoing construction projects according to the disclosed technology.

FIG. 4 depicts a conceptual illustration of an example data-analytics operation according to the disclosed technology.

FIG. 5 depicts a conceptual illustration of an example data-analytics operation according to the disclosed technology.

FIG. 6 depicts an example snapshot of a graphical user interface (GUI) that may be presented to a user according to the disclosed technology.

FIG. 7 is a conceptual illustration of an example process for generation of themes data for completed or ongoing construction projects using a problems-first analysis according to the disclosed technology.

FIG. 8 is a conceptual illustration of an example process for generation of themes data for completed or ongoing construction projects using a themes-first analysis according to the disclosed technology.

FIG. 9 depicts an example snapshot of a GUI that may be presented to a user according to the disclosed technology.

FIG. 10 depicts an example snapshot of a GUI that may be presented to a user according to the disclosed technology.

FIG. 11 is a conceptual illustration of an example process for uncovering one or more problems according to the disclosed technology.

FIG. 12 depicts an example snapshot of a GUI that may be presented to a user according to the disclosed technology.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, the present disclosure generally relates to technology for determining insights related to new or ongoing construction projects based on evaluation of data related to completed or ongoing construction projects. In practice, the disclosed technology may be incorporated into a software as a service (“SaaS”) application for managing construction projects, which may include back-end software that runs on a back-end computing platform and front-end software that runs on users' client stations (e.g., in the form of a native application, a web application, and/or a hybrid application, etc.) and can be used to access the SaaS application via a data network, such as the Internet. For example, as one possible example, the disclosed technology may be incorporated into a SaaS application for construction management, such as the one offered by Procore Technologies, Inc. However, other examples are possible as well.

### I. EXAMPLE SYSTEM CONFIGURATION

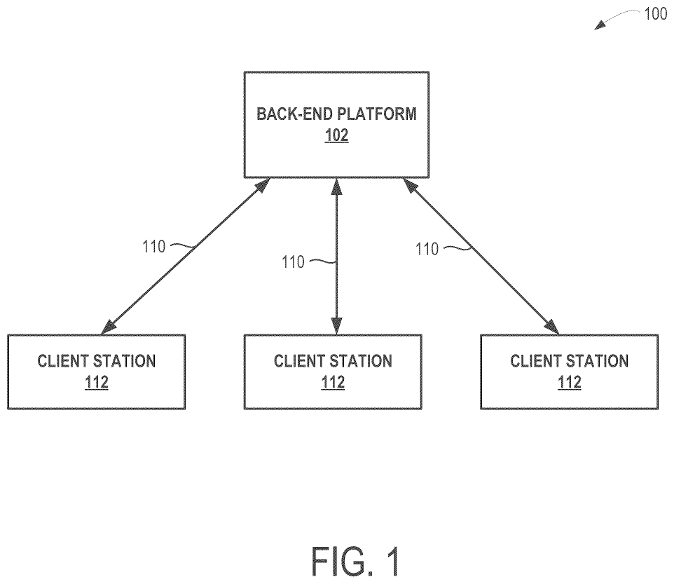

Turning now to the figures, FIG. 1 depicts an example network configuration 100 in which example embodiments of the present disclosure may be implemented. As shown in FIG. 1, network configuration 100 includes a back-end computing platform 102 that may be communicatively coupled to one or more client stations, depicted here, for the sake of discussion, as client stations 112.

Broadly speaking, back-end computing platform 102 may comprise one or more computing systems that have been installed with back-end software (e.g., program code) for hosting an example SaaS application that incorporates the disclosed technology and delivering it to users over a data network. The one or more computing systems of back-end computing platform 102 may take various forms and be arranged in various manners.

For instance, as one possibility, back-end computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like, which may be provisioned with software for carrying out one or more of the functions disclosed herein. As another possibility, back-end computing platform 102 may comprise “on-premises” computing resources of the organization that operates the example computing platform 102 (e.g., organization-owned servers), which may be provisioned with software for carrying out one or more of the functions disclosed herein. As yet another possibility, the example computing platform 102 may comprise a combination of cloud computing resources and on-premises computing resources. Other implementations of back-end computing platform 102 are possible as well.

In turn, client stations 112 may each be any computing device that is capable of accessing the SaaS application hosted by back-end computing platform 102. In this respect, client stations 112 may each include hardware components such as a processor, data storage, a communication interface, and user-interface components (or interfaces for connecting thereto), among other possible hardware components, as well as software components that facilitate the client station's ability to access the SaaS application hosted by back-end computing platform 102 and run the front-end software of the SaaS application (e.g., operating system software, web browser software, mobile applications, etc.). As representative examples, client stations 112 may each take the form of a desktop computer, a laptop, a netbook, a tablet, a smartphone, and/or a personal digital assistant (PDA), among other possibilities.

As further depicted in FIG. 1, back-end computing platform 102 may be configured to interact with client stations 112 over respective communication paths 110. In this respect, each communication path 110 between back-end computing platform 102 and one of client stations 112 may generally comprise one or more communication networks and/or communications links, which may take any of various forms. For instance, each respective communication path 110 with back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each respective communication path 110 with back-end computing platform 102 may be wireless, wired, or some combination thereof, and may carry data according to any of various different communication protocols. Although not shown, the respective communication paths 110 between client stations 112 and back-end computing platform 102 may also include one or more intermediate systems. For example, it is possible that back-end computing platform 102 may communicate with a given client station 112 via one or more intermediary systems, such as a host server (not shown). Many other configurations are also possible.

While FIG. 1 shows an arrangement in which three client stations are communicatively coupled to back-end computing platform 102, it should be understood that this is merely for purposes of illustration and that any number of client stations may communicate with back-end computing platform 102.

Although not shown in FIG. 1, back-end computing platform 102 may also be configured to interact with other third-party computing platforms, such as third-party computing platforms operated by organizations that have subscribed to the SaaS application and/or third-party computing platforms operated by organizations that provide back-end computing platform 102 with third-party data for use in the SaaS application. Such computing platforms, and the interaction between back-end computing platform 102 and such computing platforms, may take various forms.

It should be understood that network configuration 100 is one example of a network configuration in which embodiments described herein may be implemented. Numerous other arrangements are possible and contemplated herein. For instance, other network configurations may include additional components not pictured and/or more or fewer of the pictured components.

### II. EXAMPLE COMPUTING PLATFORM

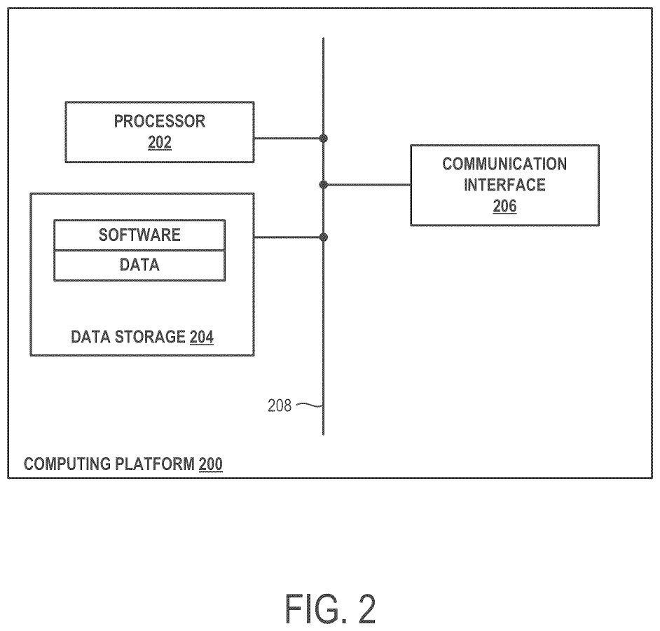

FIG. 2 is a simplified block diagram illustrating some structural components that may be included in an example computing platform 200, which could serve as, for instance, back-end computing platform 102 of FIG. 1. In line with the discussion above, computing platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processing components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums that are collectively configured to store (i) program instructions that are executable by processor 202 such that computing platform 200 is configured to perform some or all of the disclosed functions, which may be arranged together into engineering artifacts or the like, and (ii) data that may be received, derived, or otherwise stored by computing platform 200 in connection with the disclosed functions. In this respect, the one or more non-transitory computer-readable storage mediums of data storage 204 may take various forms, examples of which may include volatile storage mediums such as random-access memory, registers, cache, etc. and non-volatile storage mediums such as read-only memory, hard-disk drives, solid-state drives, flash memory, optical-storage devices, etc. Further, data storage 204 may utilize any of various types of data storage technologies to store data within the computing platform 200, examples of which may include relational databases, NoSQL databases (e.g., columnar databases, document databases, key-value databases, graph databases, etc.), file-based data stores (e.g., Hadoop Distributed File System or Amazon Elastic File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities. Further yet, in line with the discussion above, it should also be understood that data storage 204 may comprise computer-readable storage mediums that are distributed across a plurality of physical computing devices connected via a network, such as a storage cluster of a public, private, or hybrid cloud. Data storage 204 may take other forms and/or store data in other manners as well.

Communication interface 206 may be configured to facilitate wireless and/or wired communication with client stations (e.g., one or more client stations 112 of FIG. 1) and/or third-party computing platform. Additionally, in an implementation where computing platform 200 comprises a plurality of physical computing systems connected via a network, communication interface 206 may be configured to facilitate wireless and/or wired communication between these physical computing systems (e.g., between computing and storage clusters in a cloud network). As such, communication interface 206 may take any suitable form for carrying out these functions, examples of which may include an Ethernet interface, a serial bus interface (e.g., Firewire, USB 2.0, etc.), a chipset and antenna adapted to facilitate any of various types of wireless communication (e.g., WiFi communication, cellular communication, etc.), and/or any other interface that provides for wireless and/or wired communication. Communication interface 206 may also include multiple communication interfaces of different types. Other configurations are possible as well.

Although not shown, computing platform 200 may additionally include or have an interface for connecting to user-interface components that facilitate user interaction with computing system 200, such as a keyboard, a mouse, a trackpad, a display screen, a touch-sensitive interface, a stylus, a virtual-reality headset, and/or speakers, among other possibilities.

It should be understood that computing platform 200 is one example of a computing system that may be used with the embodiments described herein. Numerous other arrangements are possible and contemplated herein. For instance, other computing systems may include additional components not pictured and/or more or fewer of the pictured components.

### III. EXAMPLE OPERATIONS

As mentioned above, the present disclosure generally relates to technology for determination of insights related to construction projects based on “themes data” for completed or ongoing construction projects, which generally comprises data related to themes that are determined to correspond to construction-related problems. As further mentioned above, the determination of insights related to construction projects based on themes data for completed or ongoing construction projects described herein can be carried out by a back-end computing platform, such as back-end computing platform 102 of FIG. 1, that is hosting a SaaS application comprising front-end software running on users' client stations and back-end software running on the back-end computing platform that is accessible to the client stations via a data network, such as the Internet. For instance, the disclosed technology is described below in the context of a SaaS application for construction management, such as the SaaS application offered by Procore Technologies, Inc., but it should be understood that the disclosed technology may be utilized to determine insights related to projects based on themes data for projects in various other contexts as well.

i. Construction Project Data

In accordance with the disclosed technology, back-end computing platform 102 may be configured to facilitate management of a plurality of construction projects. In this regard, back-end computing platform 102 may create and store “construction project” data objects (or “project” data objects for short) that each represent a construction project workspace for a particular construction project in the real world. Each “project” data object may in turn be used to organize various types of other data objects related to the particular construction project. Data objects related to the particular construction project and associated with the “project” data object may generally comprise data that provides information about the particular construction project. Further, such data objects could take any of various different forms depending on the nature of the SaaS application.

For instance, a SaaS application for construction management may allow various different types of data objects related to the particular construction project to be created, stored, and accessed by users of the SaaS application. In practice, numerous types of data objects related to the particular construction project are possible, examples of which include “request for information” (“RFI”) data objects (e.g., data objects for the construction project related to requested information about given project tasks), “submittal” data objects (e.g., data objects for the construction project related to information provided by a responsible contractor (such as contractors and sub-contractors) to a general contractor), “incident” data objects (e.g., data objects for the construction project related to incidents (such as quality and/or safety incidents) that occurred during the construction project), “punch list” data objects (e.g., data objects that memorialize punch items on the construction project), “schedule” data objects (e.g., data objects that memorialize a schedule(s) related to the construction project), “inspection” data objects (e.g., data objects that memorialize an inspection(s) related to the construction project), “observation” data objects (e.g., data objects for the construction project that memorialize observations made during on-site inspections of the construction project), various types of financial-related data objects such as “budget” data objects (e.g., data objects that memorialize a budget item(s) related to the construction project), and/or “field productivity” data objects (e.g., data objects that memorialize items related to field productivity for the construction project, such items regarding time sheets and/or crews for the construction project). Other types of data objects are possible as well.

Within the SaaS application, each data-object type may represent data items of different types and thus data objects of different data-object types may be comprised of different sets of data fields compared to data objects of other data-object types. As an illustrative example of different sets of data fields, an “RFI” data object may include data fields of “RFI number,” “Subject,” “Status,” “Created By,” “Date Initiated,” “RFI Manager,” “Distribution List,” “Assignees,” “Due Date,” “Received From,” “Responsible Party,” “Drawing Number(s),” “Linked Drawing(s),” “Specification Section,” “Location,” “Schedule Impact,” “Cost Code,” “Cost Impact,” “Reference,” “Ball in Court,” “Question(s),” and/or “Response(s),” among other possibilities, whereas a “Budget” data object may include data fields of “Cost Code,” “Category,” “Original Budget Amount,” “Budget Modifications,” “Approved Cost,” “Revised Budget,” “Pending Budget Changes,” “Projected Budget,” “Committed Costs,” “Direct Costs,” “Job to Date Costs,” “Pending Cost Changes,” “Projected Costs,” “Forecast to Complete,” “Estimated Completion Date,” and/or “Projected Over/Under,” among other possibilities. Other example sets of data fields are possible as well.

Further, in at least some examples, the SaaS application for construction management may provide various software features (also referred to as tools) that allow for creation and interaction with different types of data objects. For instance, such tools may include an “RFI” tool where a user may enter RFI data items for the construction project to request and/or provide information about given project tasks, a “submittals” tool where a user may enter submittal data items, an “incidents” tool where a user may enter incident data items related to incidents (such as quality and/or safety incidents) that occurred during the construction project, a “punch list” tool where a user may enter punch list items, an “inspection” tool where a user may enter inspection items, an “observations” tool where a user may enter observation data items for the construction project that memorialize observations made during on-site inspections of the construction project, various types of financial tools such as a “budget” tool where a user may enter construction-budget items, and/or a “field productivity” tool where a user may enter field-productivity items. Other tools are possible as well. Further, in some examples, a given tool may allow a user to create, store, access, and/or modify a plurality of different types of data objects.

The stored data objects associated with the “project” data objects may be used by back-end computing platform 102 to drive various functionality for determination of insights related to construction projects based on themes data for completed or ongoing construction projects, as described in further detail below.

ii. High-Level Problems and High-Level Themes Associated with Construction Projects

Throughout a construction project, there may be high-level construction-related problems or issues that may affect the progress and/or outcome of a construction project as a whole. Various high-level construction-related problems are possible, examples of which include a cost problem (e.g., budget overrun) related to the construction project, a scheduling problem (e.g., schedule overrun) related to the construction project, a quality problem related to the construction project, and/or a safety problem related to the construction project, among other possibilities. Such construction-related problems may lead to undesirable outcomes for the construction project, such as a budget issue, a schedule issue, a quality issue, and/or a safety issue. It would be desirable to be able to recognize that these problems may be likely to occur on a construction project before they happen, so that the problems can be avoided or at least minimized during a construction project.

Furthermore, within a construction project, there may also be high-level themes (which may also be referred to herein as “topics”) that may underlie and/or otherwise be associated with construction-related problems that commonly occur on a construction project. These high-level themes may be defined in various manners, and in at least some implementations, the high-level themes may correspond to (i) different categories of labor and/or materials that are involved in a construction project, examples of which may include Heating, Ventilation, and Air Conditioning (HVAC), Concrete, Electrical, Duct Work, Ceiling Fixtures, Insulation, Walls, Demolition, Fire Protection, Garage, Hazardous Materials, Interior, Landscape, Lighting, Plumbing, and/or Telecommunications, among other possibilities and/or (ii) different categories of conflicts that may be involved in a construction project, examples of which include Utility Conflict (e.g., multiple utilities hitting each other in the design, a wall or ceiling interfering with one or more utilities and needs to be moved, etc.), a Personnel Conflict (e.g., personnel on project being overwhelmed and/or overworked, a conflict between different parties on construction project, a professionalism issue, etc.), and/or a Supply Chain Conflict (e.g., requests to substitute one product for another either due to cost or availability concerns), among other possibilities.

In order to facilitate determination of insights related to new or ongoing construction projects, back-end computing platform 102 may function to (1) generate themes data for completed or ongoing construction projects that provides indications of relationships between (i) problems that commonly occur on construction projects and (ii) themes of those construction projects that may underlie and/or otherwise be associated with those problems and then (2) use the generated themes data as a basis for determining insights related to new or ongoing construction projects.

In some examples, in order to facilitate the generation of such themes data, back-end computing platform 102 may define (i) a universe of problems of interest related to construction projects and/or (ii) a universe of themes of interest related to construction projects. In an example, back-end computing platform 102 may conduct an analysis of data objects with respect to a predefined group of problems from the universe of problems and a predefined group of themes from the universe of themes, so as to generate the themes data for construction projects. In another example, defining (i) a universe of problems of interest related to construction projects and/or (ii) a universe of themes of interest related to construction projects may involve back-end computing platform 102 conducting an analysis of data objects (e.g., using an unsupervised machine learning technique discussed in greater detail below) to determine problems and/or themes associated with the data objects. These determined problems may then define and/or be included in the universe of problems of interest related to construction projects. Similarly, these determined themes may define and/or be included in the universe of themes of interest related to construction projects.

The universe of available problems of interest related to construction projects may include any suitable construction-related problems. In an example, the universe of available problems for the analysis of data objects includes a cost problem, a scheduling problem, a quality problem, and a safety problem. However, additional and/or alternative problems in the universe of available problems are possible as well. In practice, the particular universe of problems that are available for evaluation could be defined by the SaaS application provider, the users of the SaaS application, or some combination thereof. Further yet, the particular universe of problems that are available for evaluation could vary based on factors such as the type of SaaS application and/or the type of projects being evaluated, among other possibilities.

Data objects related to construction projects may correspond to or be indicative of these problems. As an illustrative example, a first data object (e.g., an “RFI” data object) may correspond to or be indicative of cost problem, a second data object (e.g., an “observations” data object) may correspond to or be indicative of a scheduling problem, a third data object (e.g., an “inspection” data object) may correspond to or be indicative of a quality problem, and a fourth data object (e.g., an “incident” data object) may correspond to or be indicative of a safety problem. Other examples of data objects corresponding to or being indicative of high-level construction-related problems are possible as well, including but not limited to the possibility that a single data object could correspond to or be indicative of multiple different problems (e.g., both a cost problem and a schedule problem).

Further, the universe of available themes may include any suitable high-level themes that could underlie and/or otherwise be associated with construction-related problems that occur on construction projects. In an example, the universe of available themes for analysis of data objects includes HVAC, Concrete, Electrical, Duct Work, Ceiling Fixtures, Insulation, Walls, Demolition, Fire Protection, Garage, Hazardous Materials, Interior, Landscape, Lighting, Plumbing, Telecommunications, Utility Conflict, Personnel Conflict, and Supply Chain Conflict. However, additional and/or alternative themes in the universe of available themes are possible as well. Further, in some examples, the themes of the universe of available themes may be defined on a more granular level than the above example themes. For instance, there may be two or more themes for plumbing-related construction matters, such as Roof Drains, Sink Plumbing, Faucet Plumbing, Toilet Plumbing, and so forth, among other possibilities. In practice, the particular universe of themes that are available could be defined by the SaaS application provider, the users of the SaaS application, or some combination thereof. Further yet, the particular universe of themes that are available for evaluation could vary based on factors such as the type of SaaS application and/or the type of projects being evaluated, among other possibilities. Data objects related to construction projects may correspond to one or more of these high-level themes.

Problems from the universe of problems and themes from the universe of themes may be used by back-end computing platform 102 to evaluate data objects related to construction projects, so as to determine which themes associated with construction projects may be impactful or are most impactful to which problems associated with the construction projects. Such evaluation will be described in more detail below. In some situations, the evaluation by back-end computing platform 102 may reveal that different themes may be associated with different problems. For instance, a first theme (or first set of themes) may be determined to have a greater impact on a given problem than a second theme (or second set of themes).

iii. Generation of Themes Data for Completed or Ongoing Construction Projects

A. Generation of Themes Data Using Problems-First Analysis

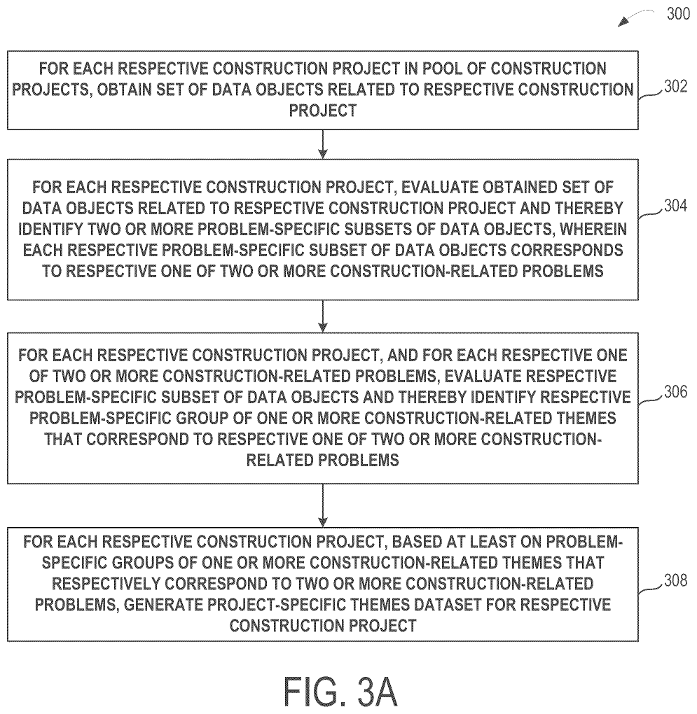

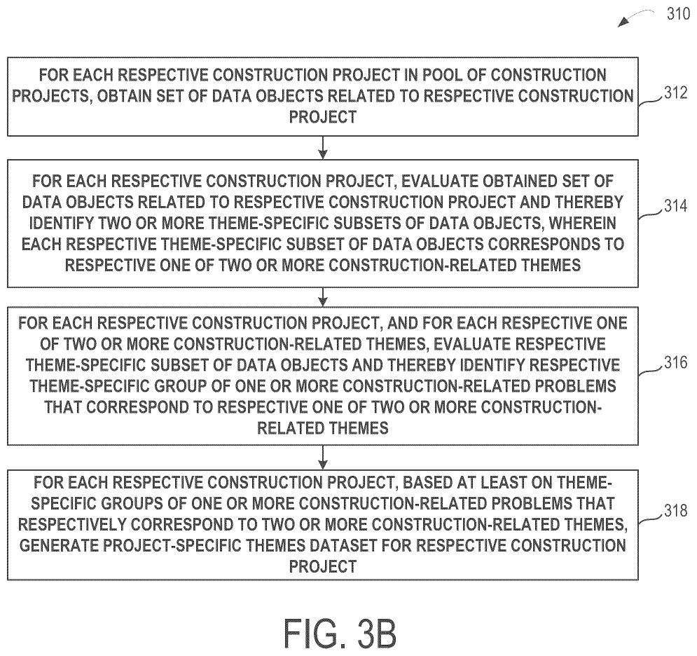

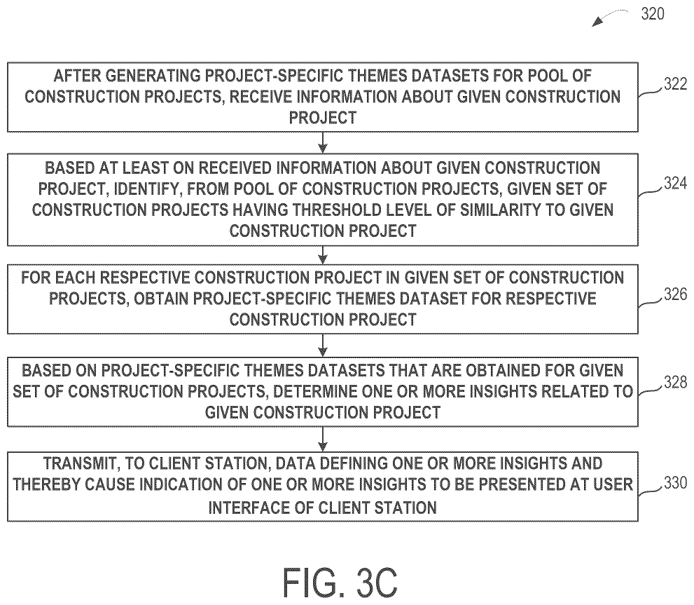

FIG. 3A depicts one example of a process 300 that may be carried out in accordance with the disclosed technology in order to facilitate determination of one or more insights related to a new or ongoing construction project based on themes data for prior (e.g., completed or ongoing) construction projects. For purposes of illustration only, example process 300 is described as being carried out by back-end computing platform 102 of FIG. 1, but it should be understood that example process 300 may be carried out by computing platforms that take other forms as well. Further, it should be understood that, in practice, the functions described with reference to FIG. 3A may be encoded in the form of program instructions that are executable by one or more processors of back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

1. Obtain Data Objects Related to Construction Projects

The example process 300 may begin at block 302, where, for each respective construction project in a pool of construction projects, back-end computing platform 102 obtains a set of data objects related to the respective construction project. As described above, back-end computing platform 102 may store a plurality of data objects for each of the construction projects of the SaaS application. Back-end computing platform 102 may obtain the sets of data objects related to the construction projects in various ways. For instance, in an example, back-end computing platform 102 may obtain the set of data objects related to each respective construction project by accessing the data objects from data storage 204.

In general, the pool of construction projects may be any appropriate pool of construction projects from which themes data for the construction projects, which as discussed above may provide an indication of relationships between problems that occur on construction projects and themes of those construction projects, may be determined. As one possibility, the pool of construction projects includes each completed or ongoing construction project that is available in the SaaS application. As another possibility, the pool of construction projects includes a subset of completed or ongoing construction projects that are available in the SaaS application. Other examples are possible as well.

Further, in general, for each respective construction project in the pool of construction projects, the obtained set of data objects may be any appropriate set of data objects from which themes data for the respective construction project may be determined. As one possibility, the set of data objects related to the respective construction project may include all or a portion of the data objects from each respective type of data object in the universe of types of data objects. For instance, in an example where the universe of types of data objects includes “RFI” data objects, “submittal” data objects, “incident” data objects, “punch list” data objects, “schedule” data objects, “inspection” data objects, “observation” data objects, “financial” data objects, and “field productivity” data objects, the set of obtained data objects may include all or a portion of the data objects from each of those types. As another possibility, the set of data objects related to the respective construction project may include all or a portion of the data objects from each respective type of data object in a subset of data objects from the universe of data objects.

2. Problem Classification of Data Objects

At block 304, for each respective construction project in the pool of construction projects, back-end computing platform 102 evaluates the obtained set of data objects related to the respective construction project and thereby identifies two or more problem-specific subsets of data objects, wherein each respective problem-specific subset of data objects corresponds to a respective one of two or more construction-related problems.

In an example, evaluating the obtained set of data objects related to the respective construction project and thereby identifying the two or more problem-specific subsets of data objects involves evaluating the obtained set of data objects related to the respective construction project in order to identify, for each respective problem in a predefined group of potential construction-related problems, a respective subset of data objects from the obtained set of data objects that correspond to the respective problem. The predefined group of potential construction-related problems may include each problem in the universe of available problems or a subset of problems from the universe of available problems. In an example where the predefined group of potential construction-related problems includes cost, scheduling, quality, and safety problems, back-end computing platform 102 may identify, for a given construction project, a first subset of data objects having data objects that each correspond to a cost problem, a second subset of data objects having data objects that each correspond to a scheduling problem, a third subset set of data objects having data objects that each correspond to a quality problem, and a fourth subset set of data objects having data objects that each correspond to a safety problem. Further, in some examples, a given data object may correspond to multiple problems, and thus the given data object may be included in two or more of the first, second, third, and fourth subsets. Still further, it should be understood that there may be a fifth subset of data objects comprising data objects that are not identified as corresponding to any of the four problems.

The function of identifying two or more problem-specific subsets of data objects, wherein each respective problem-specific subset of data objects corresponds to a respective one of two or more construction-related problems, may take various forms. In at least some implementations, back-end computing platform 102 may utilize one or more data analytics operations that serve to analyze data objects for the completed or ongoing construction project across the different types of data objects and/or tools in order to determine or predict the problem(s) to which the obtained data objects correspond. Such a data analytics operation may be performed on an object-by-object basis and may take various forms.

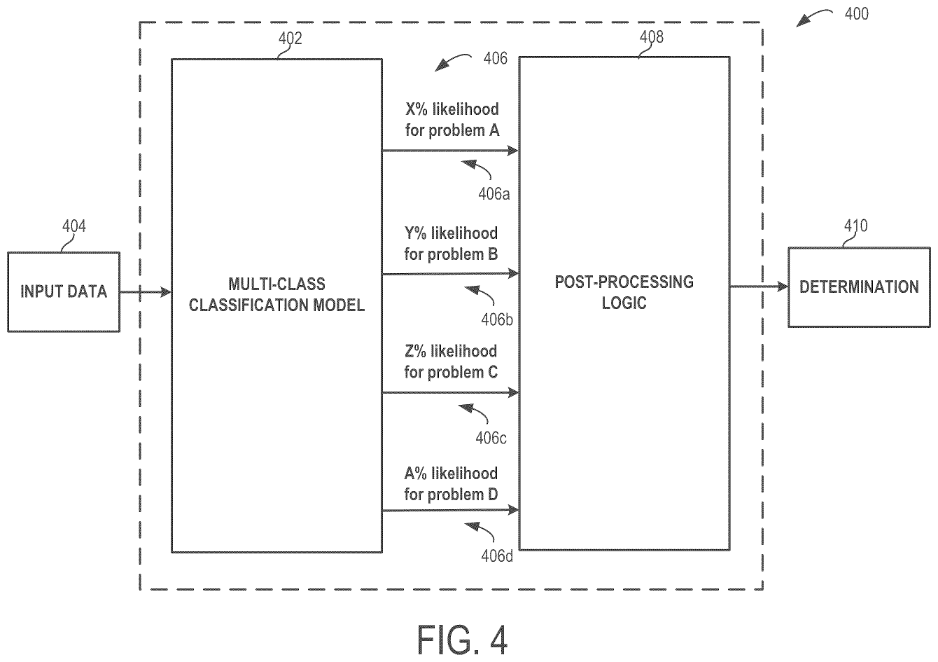

As one possibility, the data analytics carried out by back-end computing platform 102 to determine the problem(s) to which the obtained data objects correspond may be embodied in the form of one or more data science models that are each configured to determine, on an object-by-object basis, the problem(s) to which a data object correspond. In an example, such a data science model may take the form of one or more machine learning models created using a supervised machine learning technique, one example of which is a classification model. In this regard, FIG. 4 depicts a conceptual illustration of an example of a data science model 400 for predicting the problems to which data objects correspond that comprises a multi-class classification model 402 along with post-processing logic 408 that is applied to the output of multi-class classification model 402 in order to reach a determination 410 based on the model's output.

As shown in FIG. 4, multi-class classification model 402 is configured to receive input data 404 for a data object, evaluate input data 404, and then based on the evaluation, output predictions 406 that each take the form of predicted likelihood that the data object corresponds to a respective construction-related problem. For instance, as shown in FIG. 4, multi-class classification model 402 may output (1) a first prediction 406a that takes the form of a predicted likelihood that the data object corresponds to a first construction-related problem A (e.g., a cost problem), which is shown in FIG. 4 as X %, (2) a second prediction 406b that takes the form of a predicted likelihood that the data object corresponds to a second construction-related problem B (e.g., a schedule problem), which is shown in FIG. 4 as Y %, (3) a third prediction 406c that takes the form of a predicted likelihood that the data object corresponds to a third construction-related problem C (e.g., a quality problem), which is shown in FIG. 4 as Z %, and (4) a fourth prediction 406d that takes the form of a predicted likelihood that the data object corresponds to a fourth construction-related problem D (e.g., a safety problem), which is shown in FIG. 4 as A %. However, the predictions output by multi-class classification model 402 may take other forms as well.

Input data 404 for a data object that is input into multi-class classification model 402 may take various forms. In an example, for a given data object, input data 404 includes all of the data values associated with the data object. In another example, input data 404 includes a subset of the data values associated with the data object. For instance, in practice, certain data values associated with the data object (e.g., data values in certain data fields) may have more influence or weight (compared to other data values) with respect to determining which of the available problems may correspond to the data object, in which case machine-learning model 402 may be configured to receive and evaluate only a subset of the data values for a data object. As an illustrative example using an “RFI” data object having the data fields discussed above, rather than input data 404 including all of the data values for each data field of an “RFI” data object, input data 404 may include a subset of the data values for the “RFI” data object, such as the data values for the data fields of “Subject,” “Status,” “Date Initiated,” “RFI Manager,” “Assignees,” “Due Date,” “Received From,” “Responsible Party,” “Specification Section,” “Location,” “Schedule Impact,” “Cost Code,” “Cost Impact,” “Question(s),” and “Response(s).” Other examples are possible as well.

In some examples, data science model 400 may also optionally include or be associated with pre-processing logic that serves to pre-process the data values associated with the data object so as to translate those data values into “features” having an appropriate form for input into multi-class classification model 402. As one example, pre-processing may take the form of Natural Language Processing (“NLP”) techniques that analyze data values associated with the data object and translates those data values into “features” (which may also be referred to as “feature data”) having an appropriate form for input into multi-class classification model 402. Such NLP techniques may include, as some nonlimiting examples, identifying and extracting keywords and/or key features from the raw text included in user-input data, correcting any spelling and/or grammatical errors, unification, non-ascii character removal, stop word removal, lemmatization, and sentiment analysis. As an illustrative example, using an “RFI” data object having the data fields discussed above, back-end computing platform 102 may pre-process data values associated with the “Question(s)” and “Response(s)” data fields, so as to translate those data values into feature data to be input into multi-class classification model 402. For instance, the pre-processing may involve looking for phrases such as “lengthened schedule” or “additional time” in the “the “Question(s)” and “Response(s)” data fields (as such language may be indicative of a schedule problem). This matching may include a fuzziness component that looks for synonyms or near-match phrases. Other examples of pre-processing are possible as well.

In turn, post-processing logic 408 of data science model 400 may function to evaluate predictions 406 output by multi-class classification model 402 in order to reach determination 410 as to which problem(s), if any, the data object corresponds to. This post-processing logic 408 may take various forms.

As one possibility, post-processing logic 408 may function to identify the one given problem for which the data object that has the highest predicted likelihood of correspondence and then determine that the data object corresponds to that one given problem. For instance, in an example where X % likelihood is a 75% likelihood, Y % likelihood is a 65% likelihood, Z % likelihood is a 5% likelihood, and A % likelihood is a 25% likelihood, such post-processing logic 408 may function to determine that the data object corresponds to problem A only.

As another possibility, post-processing logic 408 may function to identify any problem(s) for which the data object has a predicted likelihood of correspondence that satisfies a threshold value and then determine that the data object corresponds to each identified problem (if any). The threshold value may be any suitable threshold, such as any threshold percentage likelihood of at least 50%. With reference to FIG. 4, in an example where X % likelihood is a 75% likelihood, Y % likelihood is a 65% likelihood, Z % likelihood is a 5% likelihood, A % likelihood is a 25% likelihood, and an example threshold value of 60% is used, such post-processing logic 408 may function to determine that the data object corresponds to both problem A and problem B.

As yet another possibility, post-processing logic 408 may function to identify the one given problem for which the data object has the highest predicted likelihood of correspondence and then either (i) determine that the data object corresponds to the one given problem if the predicted likelihood satisfies a threshold value, or (ii) determine that the data object does not correspond to any problem if the predicted likelihood does not satisfy the threshold value. With reference to FIG. 4, in an example where X % likelihood is a 75% likelihood, Y % likelihood is a 65% likelihood, Z % likelihood is a 5% likelihood, A % likelihood is a 25% likelihood, and an example threshold value of 70% is used, such post-processing logic 408 may determine that the data object corresponds to problem A. On the other hand, in an example where X % likelihood is a 75% likelihood, Y % likelihood is a 65% likelihood, Z % likelihood is a 5% likelihood, A % likelihood is a 25% likelihood, and an example threshold value of 80% is used, such post-processing logic 408 may function to determine that the data object does not correspond to any particular problem. Other examples of post-processing logic 408 for multi-class classification model 402 are possible as well.

In practice, multi-class classification model 402 may be created using any of various supervised learning techniques, examples of which may include a neural network technique (which is sometimes referred to as “deep learning”), a regression technique (e.g., logistic regression), a k-Nearest Neighbor (kNN) technique, a decision-tree technique (e.g., random forest), a support vector machines (SVM) technique, and/or a Bayesian technique, among other possibilities.

As mentioned above, in the example of FIG. 4, data science model 400 for predicting the problems to which data objects correspond may comprise a single machine learning model that takes the form of a multi-class classification model. However, it should be understood that data science model 400 may take other forms as well.

As one possibility, instead of a multi-class classification model, data science model 400 may comprise a plurality of binary classification models that are each configured to (i) receive input data 404 for a data object (or at least a subset thereof), evaluate input data 404, and then based on the evaluation, output a prediction that takes the form of predicted likelihood that the data object corresponds to one respective problem from the predefined group of problems. For instance, instead of the multi-class classification model 402 of FIG. 4, the data science model 400 may comprise (1) a binary first classification model that is configured to output a first prediction 402a that takes the form of a predicted likelihood that the data object corresponds to a first construction-related problem A (e.g., a cost problem), (2) a second binary classification model that is configured to output a second prediction 402b that takes the form of a predicted likelihood that the data object corresponds to a second construction-related problem B (e.g., a scheduling problem), (3) a third binary classification model that is configured to output a third prediction 402c that takes the form of a predicted likelihood that the data object corresponds to a third construction-related problem C (e.g., a quality problem), and (4) a fourth binary classification model that is configured to output a fourth prediction 402d that takes the form of a predicted likelihood that the data object corresponds to a fourth construction-related problem D (e.g., a safety problem). In such an implementation, post-processing logic 408 may then comprise either a single, global threshold that is to be applied to all of the binary classification models' outputs in order to determine whether the data object corresponds to any one or more of the problems, or a respective model-specific threshold to be applied to each binary classification model's outputs in order to determine whether the data object corresponds to the respective problem being predicted by binary classification model, among other possibilities.

As another possibility, instead of a classification model, data science model 400 for predicting the problems to which data objects correspond may comprise one or more machine learning models of another type, including but not limited to a machine learning model that is created based on an unsupervised machine learning technique such as clustering.

Using “RFI” data objects as an illustrative example in which a supervised and/or an unsupervised technique may be implemented for predicting the problems to which data objects correspond, back-end computing platform 102 may define a set of features from an RFI data object and train a machine learning model. An example set of features for an “RFI” data object may include “attached to a drawing,” “attached to change order,” and “number of responses.” After the appropriate set of features is defined, evaluation of “RFI” data objects may take an unsupervised form or a supervised form. In an unsupervised form where these data objects are clustered according to these features, back-end computing platform 102 may determine which of those clusters are attached to the problem and which are not attached to the problem. Incoming data objects may be assigned to a respective cluster and associated with a problem accordingly. In an example, the unsupervised form may be implemented utilizing an unsupervised BERTopic clustering algorithm.

In a supervised form for evaluating “RFI” data objects, back-end computing platform 102 may form a set of labeled data objects that are determined or known to be associated with a given problem, and back-end computing platform 102 may then use this set of data objects to train one or more binary or multi-class classification models that may be applied to future data objects. For each data object, these classification models may output a probability that the data object belongs to a given problem.

In an unsupervised form for evaluating “RFI” data objects, in an example, back-end computing platform 102 may create multiple clustering approaches or labeled data sets using different sets of features. Further, although these examples are described with respect to “RFI” data objects, it should be understood that these processes could be applied to other types of data objects as well.

Other types of machine learning models are possible as well.

As another possibility, the data analytics carried out by back-end computing platform 102 to determine the problem(s) to which the obtained data objects correspond may be embodied in the form of a user-defined set of rules that is applied to the obtained data objects (and more particularly, to each data object's data values) in order to determine, on an object-by-object basis, the problem(s) to which a data object correspond. In general, any suitable rule(s) to determine which one or more problems to which a data object corresponds may be utilized. As an illustrative example, using an “RFI” data object, a rule may be that if the “RFI” data object is linked to a change order over a threshold amount, that “RFI” data object is associated with a budget problem. Other examples are possible as well.

As mentioned above, there may be a plurality of types of data objects related to the construction projects. In some examples, the specific data analytics utilized to determine the problem(s) to which a data object corresponds may vary for different types of data objects. As one possibility, the data analytics carried out for a first data-object type (or a first set of data-object types) may be different than the data analytics carried out for a second data-object type (or a second set of data-object types). For instance, the data analytics carried out for a first data-object type (or a first set of data-object types) may take the form of a user-defined set of rules, whereas the data analytics carried out for a second data-object type (or a second set of data-object types) may take the form of a data science model.

As another possibility, in situations where the data analytics carried out take the form of a data science model such as data science model 400, the data science model used for a first data-object type (or a first set of data-object types) may be different than the data science model used for a second data-object type (or a second set of data-object types), and so on. For instance, the data science model used for the first data-object type may comprise a first machine learning model (or a first set of machine learning models) that is trained using historical data objects of the first data-object type (which may have a first set of data fields), whereas the data science model used for the second data-object type may comprise a second machine learning model (or a second set of machine learning models) that is trained using historical data objects of the second data-object type (which may have a second set of data fields that differs from the first set), and so on. Along similar lines, the pre-processing logic that is included and/or associated with a data science model may be different for different data-object types (e.g., a first set of pre-processing logic for a first data-object type, a second set of pre-processing logic for a second data-object type, and so on). Other examples are possible as well.

Further, in situations where the data analytics carried out take the form of a user-defined set of rules, the user-defined set of rules may be a global set of rules that gets applied to all different types of data objects. In other examples, there could be multiple different sets of rules that are specific to different data-object types. For instance, the set of rules used for a first data-object type (or a first set of data-object types) may be different than the set of rules for a second data-object type (or a second set of data-object types), and so on. As an illustrative example, a first set of rules may be used for an “RFI” data object, whereas a second set of rules may be used for a “punch list” data object. Other examples are possible as well.

As indicated above, back-end computing platform 102 may perform an evaluation of each data object in the obtained set of data objects related to the respective construction project in order to determine each problem (if any) to which the data object corresponds. In turn, back-end computing platform 102 may utilize these object-by-object problem determinations as a basis for identifying, for each respective problem, the respective problem-specific subset of data objects (from the obtained set of data objects) that corresponds to the respective problem. For instance, as one possibility, back-end computing platform 102 may update the respective subsets of data objects for the problems on an object-by-object basis as each data object is evaluated, by adding each evaluated data object to the respective subset for each problem to which the data object is determined to correspond. As another possibility, back-end computing platform 102 may assign a respective problem “label” to each data object that is evaluated to indicate the one or more problems to which the data object is determined to correspond, and then after all of the obtained data objects are evaluated, back-end computing platform 102 may build the respective problem-specific subsets of data objects for the problems based on the assigned problem labels.

3. Theme Classification of Data Objects

For each respective construction project in the pool of construction projects, after identifying the respective problem-specific subsets of the respective construction project's data objects for the different construction-related problems (e.g., the different construction-related problems in the predefined group of problems), back-end computing platform 102 may then further classify the respective problem-specific subsets of data objects according to construction-related themes. In particular, after identifying the two or more problem-specific subsets of data objects for the different problems of the two or more construction-related problems, then at block 306, back-end computing platform 102 may, for each respective one of the two or more construction-related problems, evaluate the respective problem-specific subset of data objects and thereby identify a respective problem-specific group of one or more construction-related themes that correspond to the respective one of two or more construction-related problems.

In an example, evaluating, for each respective one of the two or more construction-related problems, the respective problem-specific subset of data objects and thereby identifying a respective problem-specific group of one or more construction-related themes that correspond to the respective one of two or more construction-related problems involves evaluating the respective problem-specific subset of data objects corresponding to each such problem in order to identify, from a predefined group of potential construction-related themes, a respective problem-specific group of one or more themes corresponding to the respective problem. The predefined group of potential construction-related themes may include each theme in the universe of available themes or a subset of themes from the universe of available themes (e.g., one or more of HVAC, Concrete, Electrical, Duct Work, Ceiling Fixtures, Insulation, Walls, Demolition, Fire Protection, Garage, Hazardous Materials, Interior, Landscape, Lighting, Plumbing, Telecommunications, Utility Conflict, Personnel Conflict, and/or Supply Chain Conflict. Further, in an example where the predefined group of problems includes cost, scheduling, quality, and safety problems, back-end computing platform 102 may identify, from a predefined group of potential construction-related themes, a first problem-specific group of one or more themes corresponding to a cost problem, a second problem-specific group of one or more themes corresponding to a scheduling problem, a third problem-specific group of one or more themes corresponding to a quality problem, and a fourth problem-specific group of one or more themes corresponding to a safety problem. Further yet, in some examples, a given theme may be determined to correspond to multiple problems, and thus the given theme may be included in two or more of the first, second, third, and fourth sets of one or more themes corresponding to the problems.

In an example, in order to facilitate identifying the respective problem-specific group of one or more construction-related themes corresponding to a respective construction-related problem, back-end computing platform 102 may, for each data object in the respective subset of data objects corresponding to the respective problem, evaluate the data object to determine the theme(s) to which the data object corresponds, if any. In this regard, back-end computing platform 102 may determine the theme(s) to which a data object corresponds by assessing the extent to which the data object appears to relate to the various themes (e.g., each theme of the predefined group of themes). For instance, in an example, back-end computing platform 102 may determine that a data object corresponds to either a single theme to which the data object appears to be sufficiently related or a set of multiple themes that to which the data object appears to be sufficiently related, among other possibilities. Further, in some examples, if the evaluation reveals that a data object does not have a sufficient relationship with any of the themes, back-end computing platform 102 may determine that the data object does not correspond to any themes.

The function of determining the theme(s) to which a data object corresponds may take various forms. In at least some implementations, back-end computing platform 102 may utilize one or more data analytics operations that serve to analyze data objects across the different types of data objects and/or tools in order to determine or predict the theme(s) to which the data objects correspond. Such a data analytics operation may be performed on an object-by-object basis and may take various forms.

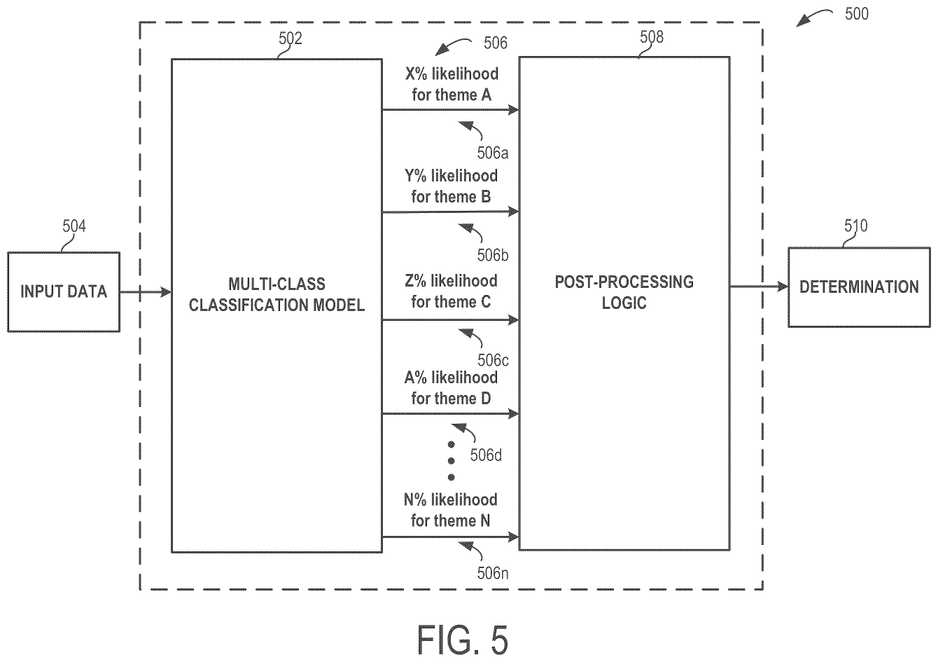

As one possibility, the data analytics carried out by back-end computing platform 102 to determine the theme(s) to which the data objects correspond may be embodied in the form of one or more data science models that are each configured to determine, on an object-by-object basis, the theme(s) to which a data object correspond. In an example, such a data science model may take the form of one or more machine learning models created using a supervised machine learning technique, one example of which is a classification model. In this regard, FIG. 5 depicts a conceptual illustration of an example of a data science model 500 for predicting the themes to which data objects correspond that comprises a multi-class classification model 502 along with post-processing logic 508 that is applied to the output of multi-class classification model 502 in order to reach a determination 510 based on the model's output.

As shown in FIG. 5, multi-class classification model 502 is configured to receive input data 504 for a data object, evaluate input data 504, and then based on the evaluation, output predictions 506 that each take the form of predicted likelihood that the data object corresponds to a respective construction-related theme. For instance, as shown in FIG. 5, multi-class classification model 502 may output (1) a first prediction 506a that takes the form of a predicted likelihood that the data object corresponds to a first construction-related theme A (e.g., HVAC), which is shown in FIG. 5 as X %, (2) a second prediction 506b that takes the form of a predicted likelihood that the data object corresponds to a second construction-related theme B (e.g., Electrical), which is shown in FIG. 5 as Y %, (3) a third prediction 506c that takes the form of a predicted likelihood that the data object corresponds to a third construction-related theme C (e.g., Concrete), which is shown in FIG. 5 as Z %, (4) a fourth prediction 506d that takes the form of a predicted likelihood that the data object corresponds to a fourth construction-related theme D (e.g., Duct Work), and so forth through (N) an Nth prediction 506n that takes the form of a predicted likelihood that the data object corresponds to an Nth construction-related theme N (e.g., Utility Conflict). However, the predictions 506 output by multi-class classification model 502 may take other forms as well.

Input data 504 for a data object that is input into the classification model 502 may take various forms. In an example, for a given data object, input data 504 includes all of the data values associated with the data object. In another example, input data 504 includes a subset of the data values associated with the data object. For instance, in practice, certain data values associated with the data object (e.g., data values in certain data fields) may have more influence or weight (compared to other data values) with respect to determining which of the available themes may correspond to the data object, in which case machine-learning model 502 may be configured to receive and evaluate only a subset of the data values for a data object. As an illustrative example using an “RFI” data object having the data fields discussed above, rather than input data 504 including all of the data values for each data field of an “RFI” data object, input data 504 may include a subset of the data values for the “RFI” data object. Other examples are possible as well.

In some examples, data science model 500 may also optionally include or be associated with pre-processing logic that serves to pre-process the data values associated with the data object so as to translate those data values into “features” having an appropriate form for input into multi-class classification model 502. As one example, pre-processing may take the form of NLP techniques that analyze data values associated with the data object and translates those data values into “features” having an appropriate form for input into multi-class classification model 502. Such NLP techniques may include, as some nonlimiting examples, identifying and extracting keywords and/or key features from the raw text included in user-input data, correcting any spelling and/or grammatical errors, unification, non-ascii character removal, stop word removal, lemmatization, and sentiment analysis. As an illustrative example, using an “RFI” data object having the data fields discussed above, back-end computing platform 102 may pre-process data values associated with the “Question(s)” and “Response(s)” data fields, so as to translate those data values into feature data to be input into multi-class classification model 502. Other examples are possible as well.

In turn, post-processing logic 508 of data science model 500 may function to evaluate the predictions 506 output by the classification model 502 in order to reach determination 510 as to which theme(s), if any, the data object corresponds to. This post-processing logic 508 may take various forms.

As one possibility, post-processing logic 508 may function to identify the one given theme for which the data object that has the highest predicted likelihood of correspondence and then determine that the data object corresponds to that one given theme. For instance, in an example where X % likelihood is a 75% likelihood, Y % likelihood is a 65% likelihood, Z % likelihood is a 45% likelihood, A % likelihood is a 25% likelihood, and N % likelihood is a 5% likelihood, such post-processing logic 508 may function to determine that the data object corresponds to theme A only.

As another possibility, post-processing logic 508 may function to identify any theme(s) for which the data object has a predicted likelihood of correspondence that satisfies a threshold value and then determine that the data object corresponds to each identified theme (if any). The threshold value may be any suitable threshold, such as any threshold percentage likelihood of at least 50%. With reference to FIG. 5, in an example where X % likelihood is a 75% likelihood, Y % likelihood is a 65% likelihood, Z % likelihood is a 45% likelihood, A % likelihood is a 25% likelihood, N % likelihood is a 5% likelihood, and an example threshold value of 60% is used, such post-processing logic 508 may function to determine that the data object corresponds to both theme A and theme B.

As yet another possibility, post-processing logic 508 may function to identify the one given theme for which the data object has the highest predicted likelihood of correspondence and then either (i) determine that the data object corresponds to the one given theme if the predicted likelihood satisfies a threshold value, or (ii) determine that the data object does not correspond to any theme if the predicted likelihood does not satisfy the threshold value. With reference to FIG. 5, in an example where X % likelihood is a 75% likelihood, Y % likelihood is a 65% likelihood, Z % likelihood is a 45% likelihood, A % likelihood is a 25% likelihood, N % likelihood is a 5% likelihood, and an example threshold value of 70% is used, such post-processing logic 508 may determine that the data object corresponds to theme A. On the other hand, in an example where X % likelihood is a 75% likelihood, Y % likelihood is a 65% likelihood, Z % likelihood is a 45% likelihood, A % likelihood is a 25% likelihood, N % likelihood is a 5% likelihood, and an example threshold value of 80% is used, such post-processing logic 508 may function to determine that the data object does not correspond to any particular theme. Other examples of post-processing logic 508 for the classification model 502 are possible as well.

In practice, multi-class classification model 502 may be created using any of various supervised learning techniques, examples of which may include a neural network technique (which is sometimes referred to as “deep learning”), a regression technique (e.g., logistic regression), a k-Nearest Neighbor (kNN) technique, a decision-tree technique (e.g., random forest), a support vector machines (SVM) technique, and/or a Bayesian technique, among other possibilities.

As mentioned above, in the example of FIG. 5, data science model 500 for predicting the themes to which data objects correspond may comprise a single machine learning model that takes the form of a multi-class classification model. However, it should be understood that data science model 500 may take other forms as well.

As one possibility, instead of a multi-class classification model, data science model 500 may comprise a plurality of binary classification models that are each configured to (i) receive input data 504 for a data object (or at least a subset thereof), evaluate input data 504, and then based on the evaluation, output a prediction that takes the form of predicted likelihood that the data object corresponds to one respective theme from the predefined group of themes. For instance, instead of the multi-class classification model 502 of FIG. 5, data science model 500 may comprise (1) a binary first classification model that is configured to output a first prediction 502a that takes the form of a predicted likelihood that the data object corresponds to a first construction-related theme A (e.g., HVAC), (2) a second binary classification model that is configured to output a second prediction 502b that takes the form of a predicted likelihood that the data object corresponds to a second construction-related theme B (e.g., Electrical), (3) a third binary classification model that is configured to output a third prediction 502c that takes the form of a predicted likelihood that the data object corresponds to a third construction-related theme C (e.g., Concrete), (4) a fourth binary classification model that is configured to output a fourth prediction 502d that takes the form of a predicted likelihood that the data object corresponds to a third construction-related theme A (e.g., Duct Work), and so forth through (N) an Nth binary classification model that is configured to output an Nth prediction 502n that takes the form of a predicted likelihood that the data object corresponds to an Nth construction-related theme N (e.g., Utility Conflict). In such an implementation, post-processing logic 408 may then comprise either a single, global threshold that is to be applied to all of the binary classification models' outputs in order to determine whether the data object corresponds to any one or more of the themes, or a respective model-specific threshold to be applied to each binary classification model's outputs in order to determine whether the data object corresponds to the respective theme being predicted by binary classification model, among other possibilities.

As another possibility, instead of a classification model, the data science model 500 for predicting the themes to which data objects correspond may comprise one or more machine learning models of another type, including but not limited to a machine learning model that is created based on an unsupervised machine learning technique such as clustering.

Other types of machine learning models are possible as well.

As another possibility, the data analytics carried out by back-end computing platform 102 to determine the theme(s) to which the data objects correspond may be embodied in the form of a user-defined set of rules that is applied to the data objects (and more particularly, to each data object's data values) in order to determine, on an object-by-object basis, the theme(s) to which a data object correspond. In general, any suitable rule(s) to determine which one or more theme to which a data object corresponds may be utilized.

As mentioned above, there may be a plurality of types of data objects related to the construction projects. In some examples, the specific data analytics utilized to determine the theme(s) to which a data object corresponds may vary for different types of data objects. As one possibility, the data analytics carried out for a first data-object type (or a first set of data-object types) may be different than the data analytics carried out for a second data-object type (or a second set of data-object types). For instance, the data analytics carried out for a first data-object type (or a first set of data-object types) may take the form of a user-defined set of rules, whereas the data analytics carried out for a second data-object type (or a second set of data-object types) may take the form of a data science model.

As another possibility, in situations where the data analytics carried out take the form of a data science model such as data science model 500, the data science model used for a first data-object type (or a first set of data-object types) may be different than the data science model used for a second data-object type (or a second set of data-object types), and so on. For instance, the data science model used for the first data-object type may comprise a first machine learning model (or a first set of machine learning models) that is trained using historical data objects of the first data-object type (which may have a first set of data fields), whereas the data science model used for the second data-object type may comprise a second machine learning model (or a second set of machine learning models) that is trained using historical data objects of the second data-object type (which may have a second set of data fields that differs from the first set), and so on. Along similar lines, the pre-processing logic that is included and/or associated with a data science model may be different for different data-object types (e.g., a first set of pre-processing logic for a first data-object type, a second set of pre-processing logic for a second data-object type, and so on). Other examples are possible as well.

Further, in situations where the data analytics carried out take the form of a user-defined set of rules, the user-defined set of rules may be a global set of rules that gets applied to all different types of data objects. In other examples, there could be multiple different sets of rules that are specific to different data-object types. For instance, the set of rules used for a first data-object type (or a first set of data-object types) may be different than the set of rules for a second data-object type (or a second set of data-object types), and so on. As an illustrative example, a first set of rules may be used for an “RFI” data object, whereas a second set of rules may be used for a “punch list” data object.

The foregoing describes an embodiment where back-end computing platform 102 first determines the respective subset of data objects corresponding to each respective problem and then performs an evaluation of each data object in the respective subset of data objects for each respective problem in order to determine each theme (if any) to which each such data object corresponds. However, it should be understood that in other embodiments, back-end computing platform 102 may first perform an evaluation of each data object in the respective construction project's obtained set of data objects in order to determine each theme (if any) to which each such data object corresponds, and may thereafter determine the respective subset of data objects corresponding to each respective problem. In either embodiment, the end result is the same, which is that a respective subset of data objects has been identified for each respective problem and a determination has also been made as to each data object's corresponding theme(s), if any.

After evaluating each data object in a respective subset of data objects for a respective problem in order to determine each theme (if any) to which each such data object corresponds, back-end computing platform 102 may then utilize these object-by-object theme determinations as a basis for identifying a respective problem-specific group of one or more themes corresponding to the respective problem. Back-end computing platform 102 may perform this identification in various ways.

As one possibility, for each respective problem of two or more construction-related problems (e.g., each problem in the predefined set of potential construction-related problems), back-end computing platform 102 may perform an evaluation of the object-by-object theme determinations across the data objects in the respective problem-specific subset of data objects corresponding to the respective problem in order to (i) determine an aggregated list of all themes that are implicated by the problem's respective problem-specific subset of data objects and (ii) determine a respective extent of the data objects in the problem's respective problem-specific subset of data objects that correspond to each theme in the aggregated list of themes (e.g., a respective percentage of the data objects in the respective problem-specific subset that correspond to each theme and/or a total number of the data objects in the respective subset that correspond to each theme), which may serve as a measure of how impactful each theme was on the respective problem on the respective construction project. For instance, based on an evaluation of the object-by-object theme determinations across the data objects in the respective problem-specific subset of data objects for a cost problem, back-end computing platform 102 may (i) determine an aggregated list of three themes that are implicated by the cost problem's respective problem-specific subset of data objects, such as HVAC, Concrete, and Electrical, and then (ii) determine a respective percentage of the data objects in the respective problem-specific subset that correspond to each of these three themes, such as X % of data objects that correspond to HVAC, Y % of data objects that correspond to Concrete, and Z % of data objects that correspond to Electrical, which may serve as a respective measure of each theme's impact on the cost problem. Other examples are possible as well.

In other examples, determining a respective extent of the data objects in the problem's respective problem-specific subset of data objects that correspond to each theme in the aggregated list of themes may involve quantifying the impact of the theme for the given problem (e.g., quantifying the total impact of the theme on the given problem and/or an average impact for each occurrence of the theme on the given problem), which may serve as a respective measure of each theme's impact on the given problem (e.g., cost problem). Quantifying the impact of the theme on the given problem may involve back-end computing platform 102 conducting an evaluation of the data objects in order to determine a quantified impact for the given data object on the problem. In some cases, quantifying the impact of the theme for the given problem may reveal that a theme that includes fewer data objects associated with a given problem has a higher impact than a theme that has a greater number of data objects associated with the given problem. For instance, back-end computing platform may determine that (i) a first theme may be less common than a second theme, but when the first theme occurs it results in a large cost impact and (ii) the second theme, while more common, causes a significantly lower cost impact. As an illustrative example, back-end computing platform 102 may identify 75 plumbing data objects (which may be, e.g., 75% of the total number of data objects in the respective subset of data objects for the cost problem) that had a total cost impact of $75K and 25 concrete data objects (which may be, e.g., 25% of the total number of data objects in in the respective subset of data objects for the cost problem) that had a total cost impact of $25M. In such a case, back-end computing platform 102 may determine that (i) each time the theme of concrete appears, it has an average impact of $1M whereas (ii) each time the theme of plumbing appears, it has an impact of $1K. Such quantified impact which may serve as a respective measure of each theme's impact on the given problem (e.g., cost problem). Other examples are possible as well.

In turn, back-end computing platform 102 may then utilize the respective measures of how impactful the themes were on the respective problem on the respective construction project to identify the one or more themes that were most impactful for the respective problem, which may then be included in the respective problem-specific group of one or more themes corresponding to the respective problem. For instance, in an example, back-end computing platform 102 may compare each theme's respective measure of impact on the respective problem to a threshold (e.g., a threshold percentage of the data objects in the respective subset that correspond to a given theme) and then identify any theme having a respective measure of impact on the respective problem that meets the threshold as one that is included in the respective problem-specific group of one or more themes corresponding to the respective problem. The threshold may be any suitable threshold, such as any threshold percentage of at least 25% of the data objects in the respective subset that correspond to a given theme. Other examples are possible as well.

As indicated above, back-end computing platform 102 may carry out the foregoing functionality on a project-by-project basis for each respective problem of two or more construction-related problems (e.g., each respective problem in the predefined group of problems), which may result in a project-by-project identification of a respective problem-specific group of one or more themes corresponding to each problem of the of two or more construction-related problems. As an illustrative example, in line with discussion above where the predefined group of problems includes cost, scheduling, quality, and safety problems, back-end computing platform 102 may carry out the foregoing functionality in order to identify, on a project-by-project basis, (1) a first problem-specific group of one or more themes corresponding to a cost problem (e.g. the one or more themes that were determined to be most impactful to instances of a cost problem that arose on the construction project), (2) a second problem-specific group of one or more themes corresponding to a scheduling problem (e.g., the one or more themes that were determined to be most impactful to instances of a scheduling problem that arose on the construction project), (3) a third problem-specific group of one or more themes corresponding to a quality problem (e.g., the one or more themes that were determined to be most impactful to instances of a quality problem that arose on the construction project), and (4) a fourth problem-specific group of one or more themes corresponding to a safety problem (e.g., the one or more themes that were determined to be most impactful to instances of a safety problem that arose on the construction project).

4. Generation of Project-Specific Themes Dataset

For each respective construction project in the pool of construction projects, after identifying the respective problem-specific groups of one or more themes corresponding to the respective problems, back-end computing platform 102 may then, for each respective construction project in the pool of construction projects, generate a project-specific themes dataset for the respective construction project. In particular, after identifying a respective problem-specific group of one or more construction-related themes that correspond to the respective one of two or more construction-related problems, then at block 308, for each respective construction project in the pool of construction projects, back-end computing platform 102, based at least on the problem-specific groups of one or more construction-related themes that respectively correspond to the two or more construction-related problems, generates a project-specific themes dataset for the respective construction project.

The project-specific themes dataset generated by back-end computing platform 102 may include various information. As one possibility, the project-specific themes dataset may include, for each respective problem, an identification of the one or more themes that are determined to correspond to the respective problem. For example, the project-specific themes dataset may include, for each respective problem, a list of the one or more themes corresponding to the respective problem.

As another possibility, in addition to the lists of one or more themes corresponding to the respective problems, the project-specific themes dataset generated by back-end computing platform 102 may include impact metrics for the theme(s). In an example, the impact metrics for the theme(s) could be the impact measures previously determined and used during the identification of the theme(s). In another example, the impact metrics for the theme(s) could be some other type of metric.

Various metrics are possible. For instance, in line with the example above where back-end computing platform 102 determined that the concrete and electrical themes correspond to a cost problem for a given construction project, back-end computing platform 102 may have determined that 75% of the data objects in the respective subset for the cost problem correspond to an electrical theme and 25% of the data objects in the respective subset for the cost problem correspond to a concrete theme. In such a situation, along with identifying the electrical and concrete themes for the cost problem, the project-specific themes dataset may include an impact percentage of 75% for the electrical theme and an impact percentage of 25% for the concrete theme. Additionally or alternatively, the impact percentages may be translated into additional metrics, such as an impact ranking (e.g., 1, 2, 3, and so forth) or an impact level (e.g., high, medium, low), among other possibilities. For instance, in line with the example above where the concrete and electrical themes correspond to a cost problem for a given construction project, the project-specific themes dataset may include an impact ranking for each theme, such as an impact ranking of “1” for the electrical theme and an impact ranking of “2” for the concrete theme, where the impact ranking of “1” indicates that electrical is the most impactful theme and the impact ranking of “2” indicates that the concrete is the second most impactful theme for the cost problem—although it will also be understood that such impact rankings could also implicitly be encoded into the listing of themes for the cost problem by ordering such themes in a defined way (e.g., in order of most impactful to least impactful or vice versa). In another example, and once again in line with the example above where the concrete and electrical themes correspond to a cost problem for a given construction project, the project-specific themes dataset may include an impact level for each theme, such as “high” for the electrical theme and an impact ranking of “low” for the concrete theme.

In other examples, the impact metrics could also take the form of metrics that quantify impact in a way that is specific to the problem at issue. As yet another possibility, the project-specific themes dataset may include additional information relating to an impact(s) of the theme(s) on the problem for the construction project. For example, for each theme corresponding to a given problem, back-end computing platform 102 may determine a quantified impact of the theme for the given problem, and back-end computing platform 102 may include such information in the project-specific themes dataset. For instance, in line with discussion above where the predefined group of problems includes cost, scheduling, quality, and safety, an impact metric for a cost problem may quantify impact in terms of cost, an impact metric for a scheduling problem may quantity impact in terms of time lost and/or associated cost, an impact metric for a quality problem may quantify impact in terms of (i) number of quality problems, (ii) a delay associated with the quality problem, and/or (iii) cost associated with the quality problem, and an impact metric for a safety problem may quantify impact in terms of (i) number of safety problems, (ii) a delay associated with the safety problem, (iii) severity of an injury or injuries associated with the safety problem and/or (iv) cost associated with the safety problem. As an illustrative example, back-end computing platform 102 may determine that a first theme led of a budget overrun of a first amount for the construction project, a second theme led of a budget overrun of a second amount for the construction project, a third theme led of a budget overrun of a third amount for the construction project, and so forth. As another illustrative example, back-end computing platform 102 may determine that a first theme led of a schedule overrun of a first amount of days for the construction project, a second theme led of a schedule overrun of a second amount of days for the construction project, a third theme led of a schedule overrun of a third amount of days for the construction project, and so forth. As yet another illustrative example, back-end computing platform 102 may determine that a first theme led to a first number of quality issues for the construction project, a second theme led to a second number of quality issues for the construction project, and so forth. As still yet another illustrative example, back-end computing platform 102 may determine that a first theme led to a first number of safety issues for the construction project, a second theme led to a second number of safety issues for the construction project, and so forth. Other example information relating to impact metrics that quantify impact in a way that is specific to the problem at issue are possible as well.

As mentioned above, quantifying the impact of the theme for the given problem may reveal that a theme that includes fewer data objects associated with a given problem has a higher impact than a theme that has a greater number of data objects associated with the given problem. Further, quantifying the impact of the theme for the given problem may reveal one or more data objects and/or events are primarily responsible for the impact on the problem. For instance, as an illustrative example, back-end computing platform 102 may identify 75 plumbing data objects (which may be, e.g., 75% of the total number of data objects in the respective subset for the cost problem) that had a total cost impact of $75K and 25 concrete data objects (which may be, e.g., 25% of the total number of data objects in in the respective subset for the cost problem) that had a total cost impact of $25M. In such a case, back-end computing platform 102 may determine that (i) each time the theme of concrete appears, it has an average impact of $1M whereas (ii) each time the theme of plumbing appears, it has an impact of $1K. Furthermore, in an example, it may be possible that one data object associated with the theme of concrete is responsible for 90% of the cost impact of $25M. In order to reflect such impact of a given theme on the problem, back-end computing platform 102 may also include as part of the impact metrics other statistical measures, such as mean and standard deviation, among other possibilities. Further, in some examples, back-end computing platform may bin events within a theme and calculate the likelihood of high-impact events (e.g., a cost impact over a first threshold) versus low-impact events (e.g., a cost impact below a second threshold).

In addition to the example impact metrics discussed above, other impact metrics are possible as well.

As yet another possibility, the project-specific themes dataset may also include data regarding one or more underlying reasons (i.e., driving forces) as to why each theme is leading to the problem. Example underlying reasons (which may also be referred to as issues, driving forces, or root causes) for problems (e.g., a cost problem, a scheduling problem, a quality problem, and a safety problem) may include scope clarification, missing information, a coordination issue, a substitution request, an unforeseen condition, a field mistake, a Personal Protective Equipment (PPE) issue (e.g., increased rate of workers being found without proper PPE), a material-planning issue (e.g., too much or not enough materials planned, which may result in a loss of economies of scale or wasted material), a drawing issue (e.g., poor drawings which may result in a conflict and redo-work), a schedule-planning issue (e.g., too compact or too long a schedule, which may create conflict, redo-work, and/or having staff longer than necessary), a staffing issue, an oversight issue, and/or a constructability issue, among other possibilities.

In this regard, in some examples, after determining which one or more themes correspond to each problem, back-end computing platform 102 may determine one or more underlying reasons as to why each theme is leading to the problem. In order to determine the one or more underlying reasons as to why each theme is leading to the problem, back-end computing platform 102 may conduct another evaluation of the data objects, this time on an object-by-object basis for each theme corresponding to each problem, in order to determine the underlying reason(s) for why each identified theme had an impact each problem. For instance, in an example, back-end computing platform 102 may determine that “concrete” is the primary theme leading to cost problems for a construction project. Further, at a level more granular than this, back-end computing platform 102 may determine that the underlying reason that “concrete” leads to cost problems for the construction project is that there are commonly coordination issues that arise when the concrete work is being done.

The function of determining or predicting the underlying reason(s) for why each identified theme had an impact each problem may take various forms, and in at least some implementations, back-end computing platform 102 may utilize one or more data analytics operations that serve to analyze the data objects across the different types of themes. Such a data analytics operation may take various forms, including, for instance, the form of a data science model or the form of a user-defined set of rules, among other possibilities.

Further, in some examples, the possible set of underlying issues could differ depending on type of data object, and thus back-end computing platform 102 may evaluate different types of data objects for different underlying issues. For instance, data objects of a first type (e.g., “RFI” data objects) may have one possible set of underlying issues that could be evaluated, whereas data objects of a second type (e.g., “submittal” data objects) may have another possible set of underlying issues that could be evaluated. Other examples are possible as well.

As mentioned above, back-end computing platform 102 may perform the operations of blocks 302-308 for each respective construction project in the pool of construction projects. In some examples, back-end computing platform 102 may be configured to periodically update the project-specific themes datasets for the completed or ongoing construction projects. Back-end computing platform 102 may update the project-specific themes datasets in various ways. As one possibility, back-end computing platform 102 may update the project-specific themes datasets based on new data objects available for one or more of the construction projects. For instance, at a first point in time (e.g., when the project-specific themes datasets for the respective construction projects are initially generated), each construction project may have a given set of data objects related to the construction project that are available for evaluation. However, at a second point in time, for each of at least one of the construction projects, there may be additional data objects available for evaluation. Such an example may occur when the construction project was an ongoing construction project that had not yet been completed. At this second point in time, back-end computing platform 102 may update the project-specific themes datasets by performing the functions of blocks 302-308 for each of the construction projects having additional data objects.

As another possibility, back-end computing platform 102 may update the project-specific themes datasets based on additional construction projects that may be added to the pool of construction projects. For instance, at a first point in time (e.g., when the project-specific themes datasets for the respective construction projects are initially generated), there may be a given number (e.g., 500) of available projects in the pool of construction projects. At a second point in time, there may be a given number (e.g., 100) of additional projects that may be added to the pool of construction projects. At this second point in time, back-end computing platform 102 may update the project-specific themes datasets by performing the functions of blocks 302-308 for the given number of additional construction projects. Other examples are possible as well.

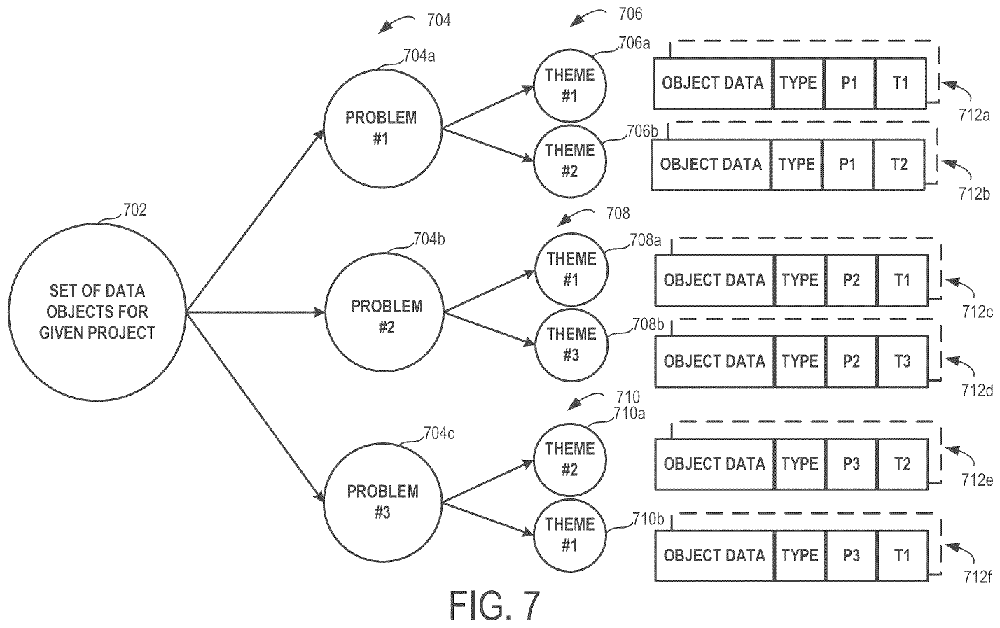

FIG. 7 is a conceptual illustration of an example process for generation of themes data for completed or ongoing construction projects using the problems-first analysis (which may also be referred to herein as the “problems-first approach”), such as example process 300. In particular, for a respective construction project in a pool of construction projects, back-end platform 102 may obtain a set of data objects 702 related to the respective construction project. Back-end computing platform 102 may evaluate the obtained set of data objects 702 and thereby identify two or more problem-specific subsets of data objects 704, wherein each respective problem-specific subset of data objects 704 corresponds to a respective one of two or more construction-related problems. In the example of FIG. 7, back-end computing platform 102 identifies (i) a problem-specific subset of data objects 704a related to a first problem (which is shown in FIG. 7 as “Problem #1”), (ii) a problem-specific subset of data objects 704b related to a second problem (which is shown in FIG. 7 as “Problem #2”), and (iii) a problem-specific subset of data objects 704c related to a third problem (which is shown in FIG. 7 as “Problem #3”). As described above, this evaluation could utilize a supervised technique (e.g., based on a predefined set of problems) or an unsupervised technique.

Further, for each respective one of the two or more construction-related problems, back-end computing platform 102 evaluates the respective problem-specific subset of data objects 704 and thereby identifies a respective problem-specific group of one or more construction-related themes that correspond to the respective one of two or more construction-related problems. In the example of FIG. 7, back-end computing platform 102 identifies (i) a problem-specific group 706 that includes themes 706a and 706b (which correspond to “Theme #1” and “Theme #2,” respectively in FIG. 7), (ii) a problem-specific group 708 that includes themes 708a and 708b (which correspond to “Theme #1” and “Theme #3,” respectively in FIG. 7), and (iii) a problem-specific group 710 that includes themes 710a and 710b (which correspond to “Theme #2” and “Theme #1,” respectively in FIG. 7). As described above, this evaluation could utilize a supervised technique (e.g., based on a predefined set of themes) or an unsupervised technique.

The data objects related to the problem-specific groups 706, 708, and 710 may be labeled with object-type, problem, and/or theme indicators. For instance, metadata fields of the data objects may include information identifying the object type, the problem, and the theme. In the example of FIG. 7, problem-specific group 706 may be associated with a set of one or more data objects 712a for objects related to “Theme 1” and a set of one or more data objects 712b for objects related to “Theme 2.” Further, problem-specific group 708 may be associated with a set of one or more data objects 712c for objects related to “Theme 1” and a set of one or more data objects 712d for objects related to “Theme 3.” Still further, problem-specific group 710 may be associated with a set of one or more data objects 712e for objects related to “Theme 2” and a set of one or more data objects 712f for objects related to “Theme 1.”

Further, based at least on the problem-specific groups 706, 708, and 710, back-end computing platform 102 may generate the project-specific themes dataset for the respective construction project. In an example, back-end computing platform 102 may generate the project-specific themes dataset for the respective construction project based on the problem-specific groups 706, 708, and 710 and the associated sets of data objects 712a-f.

B. Generation of Themes Data Using Themes-First Analysis

FIG. 3B depicts one example of a process 310 that may be carried out in accordance with the disclosed technology in order to facilitate determination of one or more insights related to a new or ongoing construction project based on themes data for prior (e.g., completed or ongoing) construction projects. For purposes of illustration only, example process 310 is described as being carried out by back-end computing platform 102 of FIG. 1, but it should be understood that example process 300 may be carried out by computing platforms that take other forms as well. Further, it should be understood that, in practice, the functions described with reference to FIG. 3B may be encoded in the form of program instructions that are executable by one or more processors of back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

1. Obtain Data Objects Related to Construction Projects

The example process 310 may begin at block 312, where, for each respective construction project in a pool of construction projects, back-end computing platform 102 obtains a set of data objects related to the respective construction project. Back-end computing platform 102 may obtain the sets of data objects related to the construction projects in various ways. In this respect, block 312 is similar in many respects to block 302, and thus is not described in as great of detail. It should be understood, however, that many of the possibilities and permutations described with respect to block 302 are also possible with respect to block 312.

2. Theme Classification of Data Objects

At block 314, for each respective construction project in the pool of construction projects, back-end computing platform 102 evaluates the obtained set of data objects related to the respective construction project and thereby identifies two or more theme-specific subsets of data objects, wherein each respective theme-specific subset of data objects corresponds to a respective one of two or more construction-related themes.

Back-end computing platform 102 may identify the two or more theme-specific subsets of data objects in various ways. Block 314 is similar in many respects to block 304 (noting, however, that rather than back-end platform 102 identifying two or more problem-specific subsets of data objects, wherein each respective problem-specific subset of data objects corresponds to a respective one of two or more construction-related problems, back-end platform 102 instead identifies two or more theme-specific subsets of data objects, wherein each respective theme-specific subset of data objects corresponds to a respective one of two or more construction-related themes) and to block 306 (in that the evaluation of the data objects is conducted with respect to themes), and thus is not described in as great of detail. It should be understood, however, that many of the possibilities and permutations described with respect to block 304 and/or block 306 are also possible with respect to block 314.

For instance, in an example, evaluating the obtained set of data objects related to the respective construction project and thereby identifying two or more theme-specific subsets of data objects involves: for each data object of the obtained set of data objects related to the respective construction project, using one or more machine learning models to output, for each respective theme from the two or more construction-related themes, a predicted likelihood that the data object corresponds to the respective theme; and based on the predicted likelihoods for the obtained set of data objects related to the respective construction project, identifying the two or more theme-specific subsets of data objects.

3. Problem Classification of Data Objects

For each respective construction project in the pool of construction projects, after identifying the respective theme-specific subsets of the respective construction project's data objects for the different construction-related themes (e.g., the different construction-related themes in the predefined group of themes), back-end computing platform 102 may then further classify the respective theme-specific subsets of data objects according to construction-related problems. In particular, after identifying the two or more problem-specific subsets of data objects for the different themes of the two or more construction-related themes, then at block 316, back-end computing platform 102 may, for each respective one of the two or more construction-related themes, evaluate the respective theme-specific subset of data objects and thereby identify a respective theme-specific group of one or more construction-related problems that correspond to the respective one of two or more construction-related themes.

Back-end computing platform 102 may identify the respective theme-specific group of one or more construction-related problems that correspond to the respective one of two or more construction-related themes in various ways. Block 316 is similar in many respects to block 306 (noting, however, that rather than back-end platform 102 identifying a respective problem-specific group of one or more construction-related themes that correspond to the respective one of two or more construction-related problems, back-end platform 102 instead identifies a respective theme-specific group of one or more construction-related problems that correspond to the respective one of two or more construction-related themes) and to block 304 (in that the evaluation of the data objects is conducted with respect to problems), and thus is not described in as great of detail. It should be understood, however, that many of the possibilities and permutations described with respect to block 306 and/or block 304 are also possible with respect to block 316.

For instance, in an example, evaluating the respective theme-specific subset of data objects and thereby identifying a respective theme-specific group of one or more construction-related problems that correspond to the respective one of two or more construction-related themes involves: for each data object of the respective theme-specific subset of data objects, using one or more machine learning models to output, for each respective problem from two or more construction-related problems, a predicted likelihood that the data object corresponds to the respective problem; and based on the predicted likelihoods for the respective theme-specific subset of data objects, identifying the respective theme-specific group of one or more construction-related problems that correspond to the respective one of two or more construction-related themes.

Furthermore, it should be understood that there may be one or more themes for which evaluation of the theme-specific subset of data objects may reveal that the theme(s) do not appear to be associated with any problems. For instance, for a given theme, the evaluation of the respective theme-specific subset of data objects may reveal that none of the construction-related problems correspond to the given theme. In such a case, there may be no theme-specific group of one or more construction-related problems for that given theme.

4. Generation of Project-Specific Themes Dataset

For each respective construction project in the pool of construction projects, after identifying the respective theme-specific groups of one or more problems corresponding to the respective themes, back-end computing platform 102 may then, for each respective construction project in the pool of construction projects, generate a project-specific themes dataset for the respective construction project. In particular, after identifying a respective theme-specific group of one or more construction-related problems that correspond to the respective one of two or more construction-related themes, then at block 318, for each respective construction project in the pool of construction projects, back-end computing platform 102, based at least on the theme-specific groups of one or more construction-related problems that respectively correspond to the two or more construction-related themes, generates a project-specific themes dataset for the respective construction project.

Back-end computing platform 102 may generate the project-specific themes dataset for the respective construction project in various ways. Block 318 is similar in many respects to block 308, and thus is not described in as great of detail. It should be understood, however, that many of the possibilities and permutations described with respect to block 308 are also possible with respect to block 318.

Further, in an example, generating a project-specific themes dataset for the respective construction project based at least on the theme-specific groups of one or more construction-related problems that respectively correspond to the two or more construction-related themes may involve identifying all of the themes for which a given problem appears in a theme-specific group and treating those identified themes as corresponding to the given problem. In such a case, the project-specific themes dataset may include, for each respective problem, an identification of the one or more themes that are determined to correspond to the respective problem. For example, the project-specific themes dataset may include, for each respective problem, a list of the one or more themes corresponding to the respective problem.

Further, in addition to generating the project-specific themes dataset for the respective construction project based on the theme-specific groups of one or more construction-related problems that respectively correspond to the two or more construction-related themes, back-end computing platform 102 may also generate the project-specific themes dataset based on sets of data objects associated with the theme-specific groups of one or more construction-related problems. In an example, evaluation of the data objects may reveal a level of impact of themes on a given problem. As an illustrative example, evaluation of the data objects may reveal that a given theme(s) may have a greater impact on a given problem than another theme, and the project-specific themes dataset generated by back-end computing platform 102 may take into account such determined impact. For instance, although a given problem may be associated with multiple themes (e.g., a first, second, and third theme), one of those themes may have a substantially larger number of data objects associated with that theme and problem. In an example, back-end computing platform may determine that the theme having a substantially larger number of data objects associated with that theme and problem has a larger impact on the problem than the other themes. Other examples are possible as well.

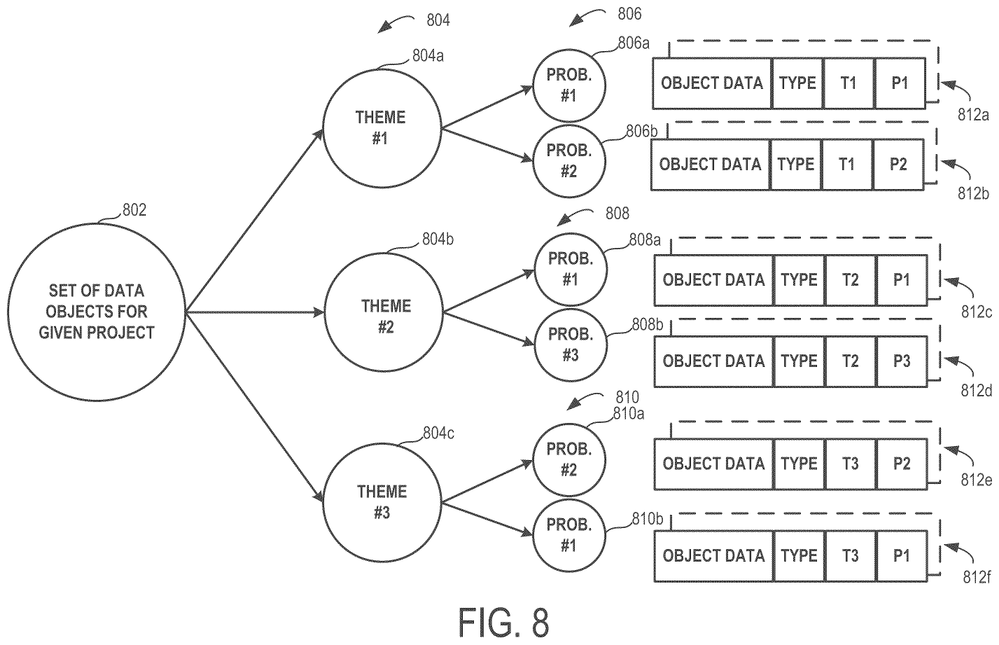

FIG. 8 is a conceptual illustration of an example process for generation of themes data for completed or ongoing construction projects using the themes-first analysis (which may also be referred to herein as the “themes-first approach”), such as example process 310. In particular, for a respective construction project in a pool of construction projects, back-end platform 102 may obtain a set of data objects 802 related to the respective construction project. Back-end computing platform 102 may evaluate the obtained set of data objects 802 and thereby identify two or more theme-specific subsets of data objects 804, wherein each respective theme-specific subset of data objects 804 corresponds to a respective one of two or more construction-related themes. In the example of FIG. 8, back-end computing platform 102 identifies (i) a theme-specific subset of data objects 804a related to a first theme (which is shown in FIG. 8 as “Theme #1”), (ii) a theme-specific subset of data objects 804b related to a second theme (which is shown in FIG. 8 as “Theme #2”), and (iii) a theme-specific subset of data objects 804c related to a third theme (which is shown in FIG. 8 as “Theme #3”). As described above, this evaluation could utilize a supervised technique (e.g., based on a predefined set of themes) or an unsupervised technique.

Further, for each respective one of the two or more construction-related themes, back-end computing platform 102 evaluates the respective theme-specific subset of data objects and thereby identifies a respective theme-specific group of one or more construction-related problems that correspond to the respective one of two or more construction-related themes. In the example of FIG. 8, back-end computing platform 102 identifies (i) a theme-specific group 806 that includes problems 806a and 806b (which correspond to “Problem #1” and “Problem #2,” respectively in FIG. 8), (ii) a theme-specific group 808 that includes problems 808a and 808b (which correspond to “Problem #1” and “Problem #3,” respectively in FIG. 8), and (iii) a theme-specific group 810 that includes problems 810a and 810b (which correspond to “Problem #2” and “Problem #1,” respectively in FIG. 8). As described above, this evaluation could utilize a supervised technique (e.g., based on a predefined set of themes) or an unsupervised technique.

The data objects related to the theme-specific groups 806, 808, and 810 may be labeled with object-type, problem, and/or theme indicators. For instance, metadata fields of the data objects may include information identifying the object type, the problem, and the theme. In the example of FIG. 8, theme-specific group 806 may be associated with a set of one or more data objects 812a for objects related to “Problem 1” and a set of one or more data objects 812b for objects related to “Problem 2.” Further, theme-specific group 808 may be associated with a set of one or more data objects 812c for objects related to “Problem 1” and a set of one or more data objects 812d for objects related to “Problem 3.” Still further, theme-specific group 810 may be associated with a set of one or more data objects 812e for objects related to “Problem 2” and a set of one or more data objects 812f for objects related to “Problem 1.”

Further, based at least on the theme-specific groups 806, 808, and 810, back-end computing platform may generate the project-specific themes dataset for the respective construction project. In an example, back-end computing platform 102 may generate the project-specific themes dataset for the respective construction project based on the problem-specific groups 806, 808, and 810 and the associated sets of data objects 812a-f.

As described above with respect to block 308, in some examples, the project-specific themes dataset may also include data regarding one or more underlying reasons (i.e., driving forces) as to why each theme is leading to the problem. In the themes-first approach, such underlying reasons may be determined in the same or similar manner as described above with respect to the problems-first approach. For instance, in an example, for each problem of a respective theme-specific group of one or more construction-related problems, back-end computing platform 102 may evaluate data objects corresponding to the theme of the respective theme-specific group and thereby identify one or more underlying reasons as to why the theme is leading to the problem. Further, in other examples, back-end computing platform 102 may, for each respective theme of the two or more themes, conduct an evaluation of the respective theme-specific subset of data objects to first identify one or more underlying reason for problems, and then back-end computing platform 102 may associate the respective theme and identified underlying reason(s) with one or more of the problems in the universe of available problems.

C. Generation of Themes Data Using Problems-First Analysis and Themes-First Analysis

In some examples, generation of themes data for completed or ongoing construction projects may involve using a problems-first approach for some data objects (e.g., data objects of a given type(s)) and using a themes-first approach for other data objects (e.g., data objects of a different given type(s)). For instance, for a first set of data objects for a given construction project, back-end computing platform 102 may conduct a problems-first approach to identify problem-specific groups (e.g., problem-specific groups 706, 708, and 710) for the first set of data objects. Further, for a second set of data objects, back-end computing platform 102 may conduct a themes-first approach to identify theme-specific groups (e.g., theme-specific groups 806, 808, and 810) for the second set of data objects. Back-end computing platform 102 may then generate the project-specific themes dataset for the given construction project based at least on (i) the problem-specific groups for the first set of data objects and (ii) the theme-specific groups for the second set of data objects. Further, generation of the project-specific themes dataset for the given construction project may also be based on the sets of data objects 712a-f and 812a-f associated with the problem-specific groups and theme-specific groups.

iv. Using Generated Themes Data for Completed or Ongoing Construction Projects to Derive Insights

A. Insights for a New or Ongoing Construction Project

After generating project-specific themes datasets for the pool of construction projects, back-end computing platform 102 may use these generated project-specific themes datasets to derive insights for new or ongoing construction projects. In an example, back-end computing platform 102 may use these generated project-specific themes datasets to derive insights specific to a new or ongoing construction project. For instance, as one possibility, the derived insights specific to a new or ongoing construction project may include predictive insights related to the new or ongoing construction project which may take the form of predictions of specific themes that are most likely to lead to specific problems on the new or ongoing construction project.

FIG. 3C depicts one example of a process 320 that may be carried out in accordance with the disclosed technology in order to facilitate determination of one or more insights related to a given construction project (e.g., a new or ongoing construction project) based on themes data for completed or ongoing construction projects. For purposes of illustration only, example process 320 is described as being carried out by back-end computing platform 102 of FIG. 1, but it should be understood that example process 320 may be carried out by computing platforms that take other forms as well. Further, it should be understood that, in practice, the functions described with reference to FIG. 3C may be encoded in the form of program instructions that are executable by one or more processors of back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

For instance, as shown in FIG. 3C, at block 322, back-end computing platform 102 receives information about a given construction project (which may also be referred to herein as a “new or ongoing construction project”).

Back-end computing platform 102 may receive information about the new or ongoing construction project in various ways. In general, receiving information about the new or ongoing construction project may involve receiving information about the new or ongoing construction project from a client station (e.g., information about the new or ongoing construction project that is input by a user into the client station and transmitted to back-end computing platform 102 over a communication network) or accessing information about the new or ongoing construction project that is previously stored by back-end computing platform 102. In an example, a user of the SaaS application may create a new construction project, and back-end computing platform 102 may receive the data about the new construction project during the standard workflow of creating the new construction project. As another example, the SaaS application may implement a workflow for requesting predictive insights related to a new or ongoing construction project, and back-end computing platform 102 may receive the information about the new or ongoing construction project during this workflow for requesting predictive insights. Other examples are possible as well.

At block 324, based at least on the received information about the new or ongoing construction project, back-end computing platform 102 may identify, from the pool of construction projects, a given set of construction projects having a threshold level of similarity to the new or ongoing construction project. In general, back-end computing platform 102 may evaluate the new or ongoing construction project compared to each of the completed or ongoing construction projects in the pool of construction projects, so as to determine or predict which completed or ongoing construction projects have a threshold level of similarity to the new or ongoing construction project.

The function of determining or predicting which completed or ongoing construction projects have a threshold level of similarity to the new or ongoing construction project may take various forms, and in at least some implementations, back-end computing platform 102 may utilize one or more data analytics operations that serve to analyze the new or ongoing construction project compared to each of the completed or ongoing construction projects in the pool of construction projects. Such a data analytics operation may take various forms, including, for instance, the form of a data science model or the form of a user-defined set of rules, among other possibilities.

In an example, a primary implementation to determine or predict which completed or ongoing construction projects have a threshold level of similarity to the new or ongoing construction project may involve a user-defined set of rules that take into account one or more factors, such as project type, planned duration, budget amount, location, and/or start date, among other possibilities. For instance, a user-defined set of rules may treat completed or ongoing construction projects as having a threshold level of similarity to the new or ongoing construction project if (i) the projects have the same project type, (ii) the projects have planned durations within a threshold amount (e.g., within 20% of one another), (iii) the projects have planned budgets within a threshold amount (e.g., within 20% of one another), (iv) the projects have locations within a threshold distance of one another (e.g., within 50 miles of one another), and/or (v) the projects have a start date within a threshold amount of time (e.g., within one year of one another), among other possibilities.

In another example, an implementation to determine or predict which completed or ongoing construction projects have a threshold level of similarity to the new or ongoing construction project may involve a data science model that is configured to use a clustering technique (or sometimes referred to as a cluster analysis) to evaluate the new or ongoing construction project compared to the completed or ongoing construction projects and output a prediction of a cluster of completed or ongoing construction projects to which the new or ongoing construction project is most similar. For instance, the data science model may have previously applied a clustering technique (such as a k-means clustering technique) to the information about the completed or ongoing construction projects and thereby defined a set of project clusters, where each such project cluster comprises a set of completed or ongoing construction projects that are deemed by the clustering technique to be sufficiently similar to one another. Thereafter, when back-end computing platform 102 receives the information about the new or ongoing construction project, the data science model may apply the clustering technique to the received information about the new or ongoing construction project in order to evaluate how the new or ongoing construction project compares to the previously-defined project clusters and thereby identify a given project cluster to which the new or ongoing construction project is most likely to belong. At least a subset of the completed or ongoing construction projects in the identified project cluster may then be identified for inclusion in the given set of completed or ongoing construction projects having a threshold level of similarity to the new or ongoing construction project.

In practice, users of the SaaS application (e.g., individuals and/or companies) may be interested in receiving one or more insights about a new or ongoing construction project based on a particular subset of completed or ongoing construction projects. For instance, a first individual may be interested in receiving one or more insights based only on completed or ongoing construction projects that the first individual's company was associated with, whereas a second individual may be interested in receiving one or more insights based on particular completed or ongoing construction projects of multiple different companies. In an example, back-end computing platform 102 may identify, from a subset of construction projects from the pool of construction projects, a given set of construction projects having a threshold level of similarity to the new or ongoing construction project. The subset of construction projects from which the given set of construction projects is identified may be determined in various ways. In an example, back-end computing platform 102 may receive a user input specifying a particular subset of new construction projects (e.g., completed or ongoing construction projects that the user's company was associated with), and back-end computing platform 102 may determine the subset of construction projects based on the user input. In another example, a given company's settings may specify a particular subset of new construction projects (e.g., completed or ongoing construction projects associated with a set of companies), and back-end computing platform 102 may determine the subset of construction projects based on the company's settings. Other examples are possible as well.

In some examples, users of the SaaS application may classify construction projects by project type, and users may customize a list of indicators of project types available for labeling a “project type” field of a “construction project” data object. Therefore, in practice, the list of indicators of project types may vary for different users. For instance, a first company may have a first list of available indicators for “project type,” and a second company may have a second, different list of available indicators for “project type.” In a situation where a user and/or company is interested in similar completed or ongoing construction projects that the user's company was associated, a primary implementation to determine or predict which completed or ongoing construction projects have a threshold level of similarity to the new or ongoing construction project may involve applying a user-defined rule that treats completed or ongoing construction projects as having a threshold level of similarity to the new or ongoing construction project if the projects have the same indicators of project type.

On the other hand, in a situation where a user and/or company may be interested in completed or ongoing construction projects associated with a set of companies, the companies in the set of companies may utilize different lists of available indicators of project types. In such a case, rather than utilizing a rule(s) based on a “project type” indicator (which may differ depending on the company applying such indicators), a primary implementation to determine or predict which completed or ongoing construction projects have a threshold level of similarity to the new or ongoing construction project may involve applying a data science model that is configured to use a clustering technique (or sometimes referred to as a cluster analysis) to evaluate the new or ongoing construction project compared to the completed or ongoing construction projects and output a prediction of a cluster of completed or ongoing construction projects to which the new or ongoing construction project is most similar. In an example, the data science model may cluster projects based on various factors, such as percentage of overall budget related to each cost division, among other possibilities. Clustering based on one or more such factors may facilitate determining that dissimilar-sounding projects (e.g., a school and a medical office building) are actually very similar in certain aspects and can be considered part of a cluster for certain analyses.

At block 326, back-end computing platform 102, for each respective construction project in the given set of construction projects having a threshold level of similarity to the new or ongoing construction project, obtains the project-specific themes dataset for the respective construction project. Back-end computing platform 102 may obtain these project-specific themes dataset in various ways, such as by accessing the project-specific datasets from data storage 204.

At block 328, back-end computing platform 102, based on the project-specific themes datasets that are obtained for the given set of construction projects having a threshold level of similarity to the new or ongoing construction project, determines one or more insights related to the new or ongoing construction project.

In order to determine the one or more insights related to the new or ongoing construction project, back-end computing platform 102 may, on a problem-by-problem basis, aggregate the themes data across the given set of construction projects to come up with aggregated themes data. One or more insights may be determined based on this aggregated themes data. Given the similarity between the new or ongoing construction project and the given set of construction projects, this aggregated themes data may provide an indication of which one or more themes (and/or underlying issues) may be likely to be most impactful for each problem that may arise on the new or ongoing construction project.

The one or more insights may include insights related to each respective problem in the predefined group of problems, or some subset thereof. In general, any suitable insights may be generated.

As one possibility, an insight for a given problem may include a prediction of the most impactful theme(s) for a respective problem as determined based on the given set of construction projects. Back-end computing platform 102 may derive such a prediction in various ways, including, for instance, aggregating themes data from the project-specific themes datasets that are obtained for the given set of construction projects to determine respective problem-specific aggregated themes data for the given set of construction projects and determining a prediction based on the aggregated problem-specific themes data. As one example, back-end computing platform 102 may (i) determine an aggregated list of all themes that were determined to correspond to a respective problem across the given set of completed or ongoing construction projects and (ii) for each respective theme in the aggregated list of themes, determine a respective extent of the completed or ongoing construction projects in the given set for which the respective theme was determined to correspond to the respective problem (e.g., a respective percentage of the completed or ongoing construction projects in the given set and/or a total number of the completed or ongoing construction projects in the given set), which may serve as a measure of how impactful each theme was on the respective problem across the completed or ongoing construction projects in the given set. In turn, back-end computing platform 102 may then utilize the respective measures of how impactful the themes were on the respective problem across the completed or ongoing construction projects in the given set to identify the one or more themes that were most impactful for the respective problem. For instance, in an example, back-end computing platform 102 may compare each theme's respective measure of impact on the respective problem to a threshold (e.g., a threshold percentage of the completed or ongoing construction projects in the given set) and then identify any theme having a respective measure of impact on the respective problem that meets the threshold as one that is predicted to be an impactful theme for the respective problem.

As another example, in a situation where the themes data across the given set of construction projects includes each theme's impact percentage to a problem, back-end computing platform 102 may, for each theme corresponding to a problem, aggregate the impact percentage to the problem across the projects in the given set of construction projects and (ii) determine an average impact percentage for the theme to the problem. This average impact percentage may give another assessment of impact of the theme to the problem across the given set of construction projects. Other example ways to derive a prediction of the most impactful theme(s) for a respective problem as determined based on the given set of construction projects are possible as well.

As another possibility, the one or more insights may also include an indication, on a theme-by-theme basis, of a percentage of the projects of the given set of construction projects in which the theme was determined to be impactful for the given problem.

As yet another possibility, in examples where the project-specific themes datasets include data related to the one or more underlying reasons (i.e., driving forces) as to why each theme is leading to the problem, the one or more insights may take into account the underlying reasons.

As yet another possibility, an insight may include an average impact of a theme for the given problem. For example, back-end computing platform 102 may determine, on a theme-by-theme basis, an average cost impact of that theme for the given set of construction projects. As another example, back-end computing platform 102 may determine, on a theme-by-theme basis, an average schedule impact of that theme for the given set of construction projects. Other insights are possible as well.

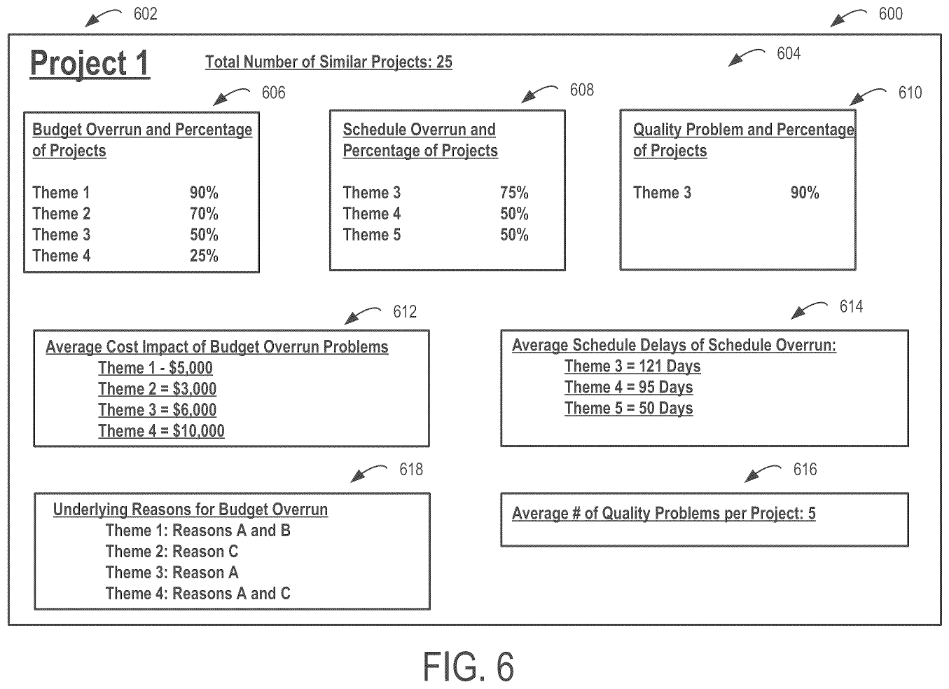

At block 330, back-end computing platform 102, transmit, to a client station, data defining the one or more insights and thereby cause an indication of the one or more insights to be presented at a user interface of the client station. The indication of the one or more insights to be presented at the user interface of the client station may take various forms. FIG. 6 depicts an example snapshot 600 of a GUI 602 that displays information regarding the one or more insights. GUI 602 includes an indication 604 of the one or more insights. In this example, the indication 604 comprises a plurality of indicators for different insights, including an indicator 606 for an insight related to a cost problem, an indicator 608 for an insight related to a scheduling problem, an indicator 610 for an insight related to a quality problem, and indicator 612 for an insight related to a cost impact, an indicator 614 for an insight related to a schedule impact, an indicator 616 for an insight related to average number of quality problems per similar project, and an indicator 618 related to underlying reasons for budget overrun. Other examples are possible as well.

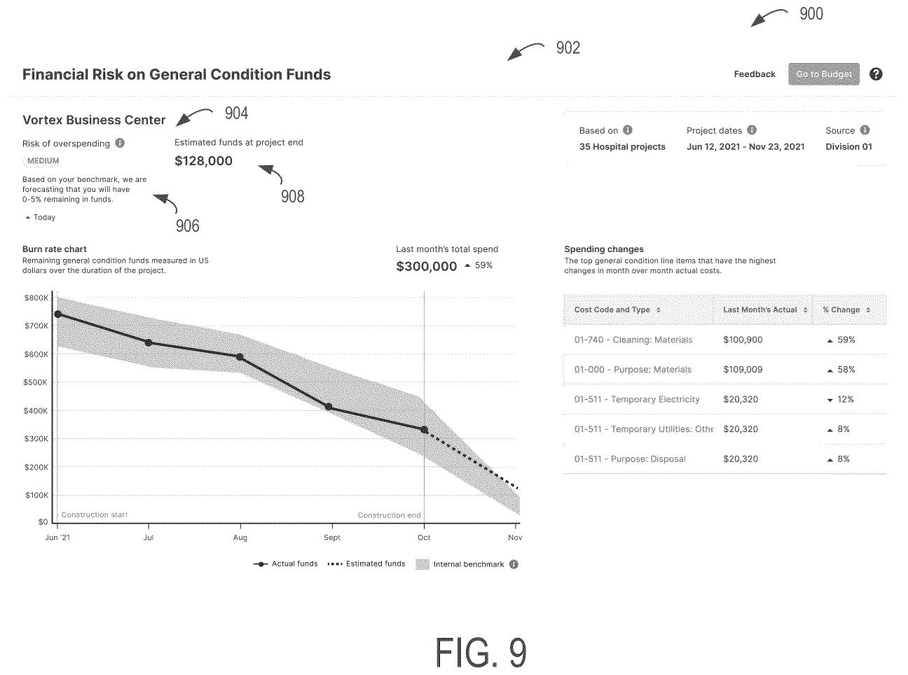

FIG. 9 depicts another example snapshot 900 of a GUI 902 that displays information regarding the one or more insights. GUI 902 includes an indication 904 of the one or more insights. In this example, the indication 904 comprises an indicator 906 for an insight related to a cost problem (which indicates the risk of overspending is “Medium” and it is forecasted that the project will have 0-5% remaining in funds) and an indicator 908 indicating that the estimated funds at project end are $128,000.

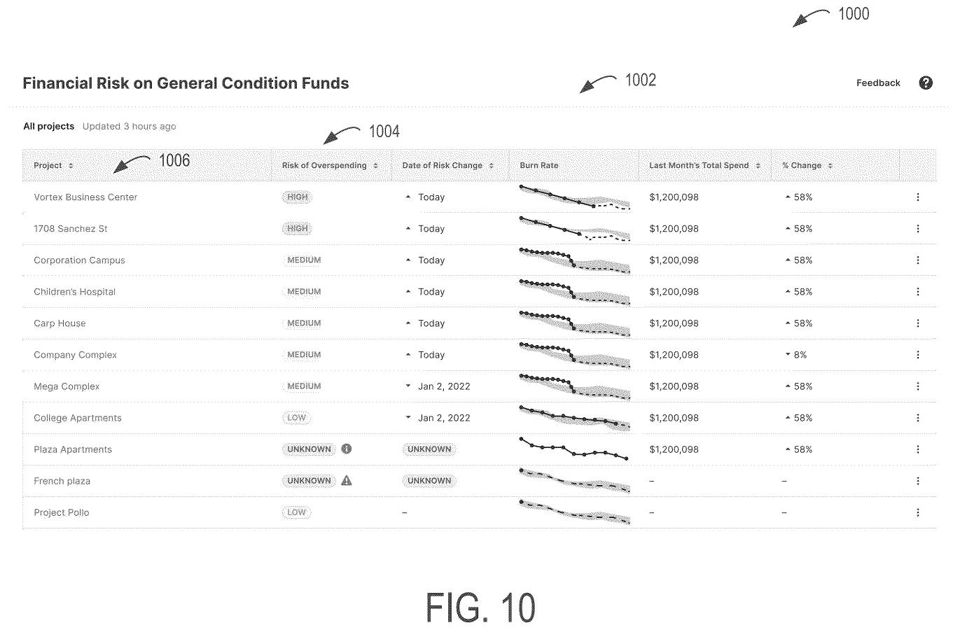

In an example, back-end computing platform 102 may determine, for each respective construction project of a plurality of construction projects, one or more insights related to the given construction project and cause an indication of one or more insights for each project to be presented at a user interface of a client station. For instance, back-end computing platform 102 may determine one or more insights for each project of a given general contractor and cause an indication of one or more insights for each project of that given general contractor to be presented at a user interface of a client station associated with the general contractor. FIG. 10 depicts an example snapshot 1000 of a GUI 1002 that displays information regarding insights for a plurality of construction projects, such as those of a general contractor. GUI 1002 includes indications 1004 of insights for projects 1006 that indicate, for each project, a respective risk of overspending.

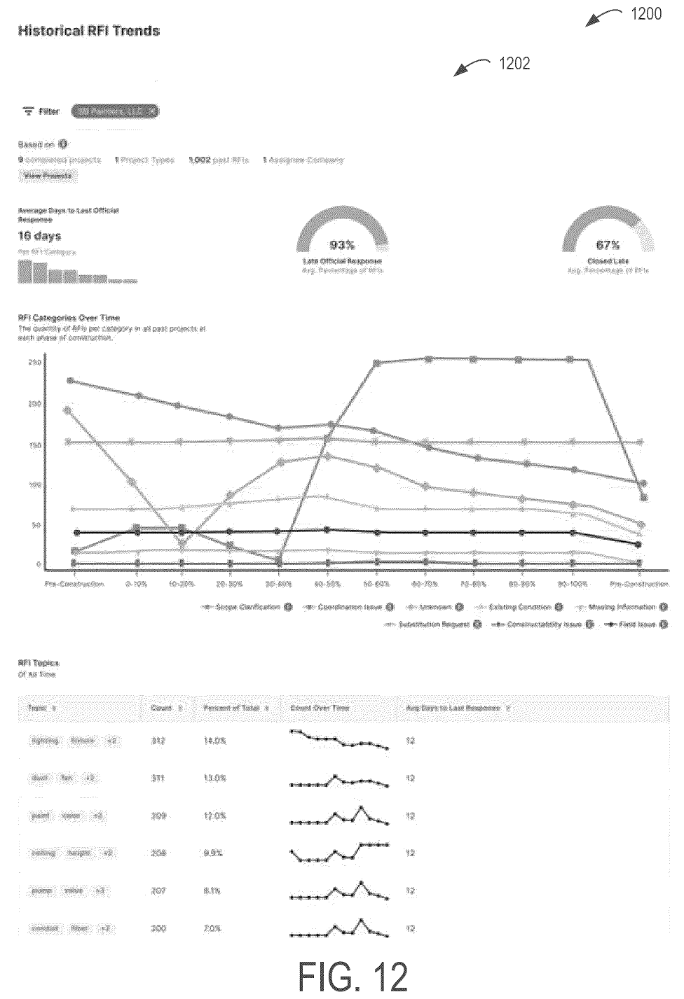

FIG. 12 depicts yet another example snapshot 1200 of a GUI 1202 that displays information regarding one or more insights. In the example of FIG. 12, GUI 1202 includes an indication for a plurality of insights related to a construction project for a given company. The displayed insights of the example of FIG. 12 may be based on project-specific themes datasets that are obtained for a given set construction projects (which is indicated in FIG. 12 as a set of nine completed construction projects). In this example of FIG. 12, the indication comprises a plurality of indicators for various insights. For instance, the indication includes a plurality of indicators related to underlying reasons for problems (more particularly, indicating the quantity of RFIs per underlying reason (also referred to in GUI 1202 as “category”) in the past projects of the given set at various phases of construction). The indication also includes a plurality of indicators that indicate, on a theme-by-theme basis, (i) the number of “RFI” data objects per theme (also referred to in GUI 1202 as “topic”), (ii) the percent of total number of RFIs, and (iii) the count over time throughout past projects. Although six themes are shown in GUI 1202, it should be understood that additional themes are possible as well.

Other example interfaces for presenting one or more insights are possible as well. Further, in the example of FIG. 12, the insights are derived from themes datasets based on “RFI” data objects. However, in line with the discussion above, insights may be derived from themes datasets based on additional and/or alternative types of data objects.

As mentioned above, back-end computing platform 102 may receive the information about the new or ongoing construction project from a client station. In some examples, the client station from which the information about the new or ongoing construction project was received is the same as the client station on which the indication of the one or more insights is presented. On the other hand, in other examples, the client station on which the indication of the one or more insights is presented may be a first client station, and the client station from which the information about the new or ongoing construction project was received may be a second, different client station. As one possibility, the first client station and the second client station may be different client stations associated with the same user. For instance, the first client station may be a computer of the user, and the second client station may be a phone of the user. As another possibility, the first client station may be a client station of a first user, and the second client station may be a client station of a different, second user. For instance, the first client station may be a client station used by a first user associated with the new or ongoing construction project, and the second client station may be a client station of a second user associated with the new or ongoing construction project. Other examples are possible as well.

B. Other Types of Insights

As mentioned above, after generating project-specific themes datasets for the pool of construction projects, back-end computing platform 102 may use these generated project-specific themes datasets to derive insights specific to a new or ongoing construction project. In addition to or alternative to deriving specific insights about a new or ongoing construction project using these generated project-specific themes datasets, back-end computing platform 102 may generate other insights using these generated project-specific themes datasets, such as pre-defined insights about construction projects and/or insights about particular aspects of construction projects.

1. Pre-Defined Insights about Construction Projects

Turning first to pre-defined insights about construction projects, in some examples, back-end computing platform 102 may generate predefined insights about construction projects using these generated project-specific themes datasets. In general, back-end computing platform 102 may generate a variety of different pre-defined insights based on the project-specific themes datasets for the pool of construction projects. These pre-defined insights about construction projects may be insights that are generated without being specific to a given new or ongoing construction project and the pre-defined insights about construction projects may take various forms. As one possibility, back-end computing platform 102 may aggregate the generated project-specific themes datasets across respective sets of construction projects associated with a given building type. Back-end computing platform 102 may then determine, based on the aggregated project-specific themes datasets, one or more insights related to construction projects associated with the given building type. For instance, back-end computing platform 102 may aggregate the generated project-specific themes datasets across respective sets of construction projects associated with schools, and back-end computing platform 102 may then determine, based on the aggregated project-specific themes datasets, one or more insights related to construction projects associated with schools.

As another possibility, back-end computing platform 102 may aggregate the generated project-specific themes datasets across respective sets of construction projects associated with a given building location. Back-end computing platform 102 may then determine, based on the aggregated project-specific themes datasets, one or more insights related to construction projects associated with the given building location. For instance, back-end computing platform 102 may aggregate the generated project-specific themes datasets across respective sets of construction projects associated with a given city, and back-end computing platform 102 may then determine, based on the aggregated project-specific themes datasets, one or more insights related to construction projects associated with the given city. Other predefined insights about construction projects are possible as well.

2. Insights about Particular Aspects of Construction Projects

Turning next to insights about particular aspects of construction projects, in some examples, back-end computing platform 102 may generate one or more insights about particular aspects of construction projects using themes datasets. For instance, back-end computing platform 102 may generate one or more insights about a given company (e.g., a given contractor, a given sub-contractor), a given construction professional (e.g., a given architect), a given stakeholder, and/or a given trade, among other possibilities.

Back-end computing platform 102 may generate one or more insights about the selected particular aspect in various ways.

As one possibility, back-end computing platform 102 may generate one or more insights about a given particular aspect using at least some of the generated project-specific themes datasets. For example, back-end computing platform 102 may aggregate the generated project-specific themes datasets across respective sets of construction projects associated with the particular aspect of construction projects. Back-end computing platform 102 may then determine, based on the aggregated project-specific themes datasets, one or more insights related to construction projects associated with the particular aspect of construction projects.

Prior to generating one or more insights about a particular aspect of construction projects using at least some of the generated project-specific themes datasets, back-end computing platform 102 may receive a user input selecting a particular aspect of a construction project (e.g., such as a given company, a given construction professional, a given stakeholder, or a given trade). Based at least on the selected particular aspect, back-end computing platform 102 may identify, from the pool of construction projects, a given set of construction projects associated with the particular selected aspect (e.g., a selected given company, given construction professional, given stakeholder, or given trade). Back-end computing platform 102 may then, for each respective construction project in the given set of construction projects, obtain the project-specific themes dataset for the respective construction project. Back-end computing platform 102 may then, based on the project-specific themes datasets that are obtained for the given set of construction projects, determine one or more insights related to the selected particular aspect. Back-end computing platform 102 may then, transmit to a client station data defining the one or more insights and thereby cause an indication of the one or more insights to be presented at a user interface of the client station.

As another possibility, back-end computing platform 102 may generate one or more insights about a given particular aspect using data objects associated with the particular aspect. For example, back-end computing platform 102 may obtain data objects associated with the particular aspect and determine one or more insights related to the particular aspect based on the labeled theme indicators and problem indicators of those data objects associated with the particular aspect.

In an example, prior to generating one or more insights about a particular aspect of construction projects using data objects associated with the particular aspect, back-end computing platform 102 may receive a user input selecting a particular aspect of a construction project, such as a given company, a given construction professional, a given stakeholder, or a given trade. Based at least on the selected particular aspect, back-end computing platform 102 may obtain data objects related to the selected aspect. As a particular example in which the selected aspect is a given architect, back-end computing platform 102 may obtain data objects related to the given architect. In an example, data objects that have previously been labeled with object-type, problem, and/or theme indicators may also have previously been labeled with an architect indicator. Back-end computing platform 102 may filter the labeled data-object data to identify the obtained data objects related to the given architect. Back-end computing platform 102 may then (i) evaluate the obtained data objects (and associated labeled themes and problems) to determine one or more insights related to the particular aspect and (ii) transmit, to a client station, data defining the one or more insights and thereby cause an indication of the one or more insights to be presented at a user interface of the client station.

As yet another possibility, back-end computing platform 102 may generate themes data for particular aspects of construction projects and thereafter generate one or more insights about a selected particular aspect using the generated themes data for particular aspects of construction projects. For instance, in an example where the particular aspect is a given company (e.g., a given contractor, a given sub-contractor), back-end computing platform 102 may generate themes data for companies (e.g., company-specific themes datasets) and thereafter use that generated themes data for generating one or more insights related to a given company. Further, in an example where the particular aspect is a given construction professional (e.g., a given architect), back-end computing platform 102 may generate themes data for construction professionals (e.g., construction-professional-specific themes datasets) and thereafter use that generated themes data for generating one or more insights related to a given construction professional. Still further, in an example where the particular aspect is a given stakeholder, back-end computing platform 102 may generate themes data for stakeholder and thereafter use that generated themes data for generating one or more insights related to a given stakeholder. Yet still further, in an example where the particular aspect is a given trade, back-end computing platform 102 may generate themes data for one or more trades (e.g., trade-specific themes datasets) and thereafter use that generated themes data for generating one or more insights related to a given trade. Other examples are possible as well.

As an illustrative example of generating themes data for particular aspects of construction projects, back-end computing platform 102 may generate architect-specific themes datasets for a pool of architects. Generating the architect-specific themes datasets for a pool of architects may take various forms. In some examples, architect-specific themes datasets for a pool of architects may be generated using a problems-first approach. For instance, for each respective architect in a pool of architects, back-end computing platform 102 may (i) obtain a set of data objects related to the respective architect, (ii) evaluate the obtained set of data objects related to the respective architect and thereby identify two or more problem-specific subsets of data objects, wherein each respective problem-specific subset of data objects corresponds to a respective one of two or more construction-related problems; (iii) for each respective one of the two or more construction-related problems, evaluate the respective problem-specific subset of data objects and thereby identify a respective problem-specific group of one or more construction-related themes that correspond to the respective one of two or more construction-related problems; and (iv) based at least on the problem-specific groups of one or more construction-related themes that respectively correspond to the two or more construction-related problems, generate an architect-specific themes dataset for the respective architect.

In other examples, architect-specific themes datasets for a pool of architects may be generated using a themes-first approach. For instance, for each respective architect in a pool of architects, back-end computing platform 102 may (i) obtain a set of data objects related to the respective architect, (ii) evaluate the obtained set of data objects related to the respective architect and thereby identify two or more theme-specific subsets of data objects, wherein each respective theme-specific subset of data objects corresponds to a respective one of two or more construction-related themes; (iii) for each respective one of the two or more construction-related themes, evaluate the respective theme-specific subset of data objects and thereby identify a respective theme-specific group of one or more construction-related problems that correspond to the respective one of two or more construction-related themes; and (iv) based at least on the theme-specific groups of one or more construction-related problems that respectively correspond to the two or more construction-related themes, generate an architect-specific themes dataset for the respective architect.

Back-end computing platform 102 may use these generated architect-specific themes datasets to generate one or more insights about particular architects. For instance, back-end computing platform may receive a user input selecting a particular architect. Back-end computing platform 102 may (i) obtain the architect-specific themes dataset for the selected particular architect. (ii) based on the obtained architect-specific themes dataset, determine one or more insights related to the particular architect, and (iii) transmit, to a client station, data defining the one or more insights and thereby cause an indication of the one or more insights to be presented at a user interface of the client station.

Although this illustrative example is described with respect to architects, it should be understood that themes data may be generated for any desired particular aspect of a construction project, such as companies, other construction professionals, stakeholders, and/or trades, among other possibilities.

v. Precursor Problem-Space Identification

As described above, in some examples, evaluating data objects using supervised techniques may involve evaluating data objects with respect to predefined problems from a universe of available problems. In some examples, prior to such evaluating data objects using supervised techniques, back-end computing platform 102 may conduct an evaluation of data objects related to construction projects in order to uncover (or otherwise identify) one or more problems that may thereafter be added to the universe of available problems that may be utilized when evaluating data objects using supervised techniques.

As one possibility, using unsupervised techniques to cluster data objects into themes, back-end computing platform 102 may analyze the data objects to determine what themes are surfacing and then associate those themes with known problems (e.g., a cost problem, a scheduling problem, a quality problem, and a safety problem) or discover one or more yet unknown problems. The one or more yet unknown problem may be any problem identified based on the analysis, one example of which may be a morale problem. Other example yet unknown problems are possible as well.

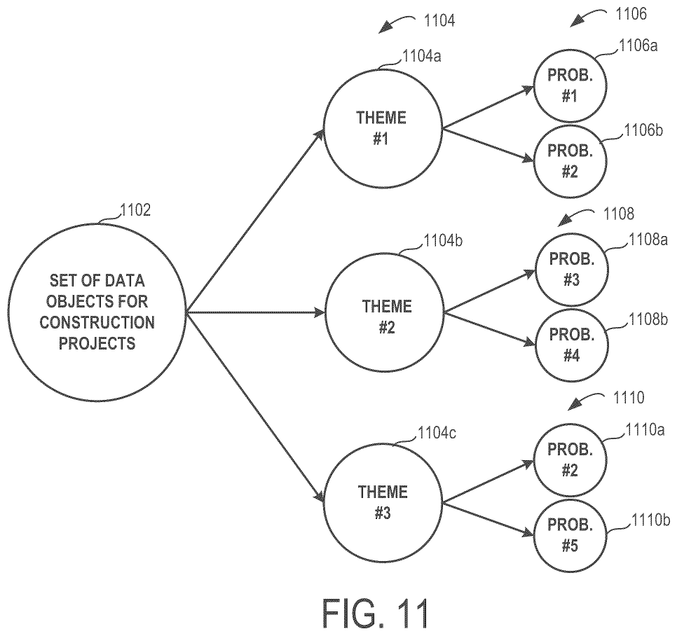

FIG. 11 is a conceptual illustration of an example process for uncovering one or more problems. In particular, back-end platform 102 may obtain a set of data objects 1102 related a pool of construction projects. In some examples, the obtained set of data objects 1102 may be a set of data objects of a given data-object type. Further, in some examples, the pool of construction projects for problem-space identification is a different pool of construction projects than the pool of construction projects discussed with respect to FIGS. 3A-3C. In other examples, the set of construction projects in the pool of construction projects for problem-space identification overlaps at least in part the set of construction projects in the pool of construction projects discussed with respect to FIGS. 3A-3C.

Back-end computing platform 102 may evaluate the obtained set of data objects 1102 and thereby identify two or more theme-specific subsets of data objects 1104, wherein each respective theme-specific subset of data objects 1104 corresponds to a respective one of two or more construction-related themes. In the example of FIG. 11, back-end computing platform 102 identifies (i) a theme-specific subset of data objects 1104a related to a first theme (which is shown in FIG. 11 as “Theme #1”), (ii) a theme-specific subset of data objects 1104b related to a second theme (which is shown in FIG. 11 as “Theme #2”), and (iii) a theme-specific subset of data objects 1104c related to a third theme (which is shown in FIG. 11 as “Theme #3”). This evaluation could utilize an unsupervised technique.

Further, for each respective one of the two or more construction-related themes, back-end computing platform 102 evaluates the respective theme-specific subset of data objects to identify a respective set of one or more problems corresponding to the respective one of two or more construction-related themes. In the example of FIG. 11, back-end computing platform 102 identifies (i) a set 1106 that includes problems 1106a and 1106b (which correspond to “Problem #1” and “Problem #2,” respectively in FIG. 11), (ii) a set 1108 that includes problems 1108a and 1108b (which correspond to “Problem #3” and “Problem #4,” respectively in FIG. 11), and (iii) a set 1110 that includes problems 1110a and 1110b (which correspond to “Problem #2” and “Problem #5,” respectively in FIG. 11). This evaluation could utilize an unsupervised technique.

Back-end computing platform 102 may then, based on the respective sets of one or more problems corresponding to the respective one of two or more construction-related themes, identify a problem space of construction-related problems. For instance, the problem space shown in FIG. 11 includes “Problem #1,” “Problem #2,” “Problem #3,” “Problem #4,” and “Problem 5.” Further, in an example, “Problem #1,” “Problem #2,” “Problem #3,” and “Problem #4” may correspond to known problems such as a cost problem, a scheduling problem, a quality problem, and a safety problem, whereas “Problem #5” may correspond to a newly identified problem such as a morale problem, among other possibilities. In some examples, after identifying the problem space using unsupervised techniques, each problem in the problem space may then be utilized when evaluating data objects using supervised techniques, such as those described with respect to FIGS. 3A-B and 7-8.

Similar to the examples discussed above with respect to FIGS. 7-8, the data objects related to the sets 1106, 1108, and 1110 may be labeled with object-type, problem, and/or theme indicators. Further, in some examples, back-end computing platform 102 may use this data to train machine learning models that use supervised learning techniques for predicting problems and/or themes (as described above with respect to FIGS. 3A-3B).

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

For instance, those in the art will understand that the disclosed operations for determining one or more insights based on themes data may not be limited to only construction projects. Rather, the disclosed operations could be used in other contexts in connection with other types of projects as well.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
a network interface;
at least one processor;
a non-transitory computer-readable medium; and
program instructions stored on the non-transitory computer-readable medium that are executable by the at least one processor such that the computing platform is configured to:
for each respective construction project in a pool of construction projects:
(i) obtain a set of data objects related to the respective construction project;
(ii) evaluate the obtained set of data objects related to the respective construction project and thereby identify two or more theme-specific subsets of data objects, wherein each respective theme-specific subset of data objects corresponds to a respective one of two or more construction-related themes;
(iii) for each respective one of the two or more construction-related themes, evaluate the respective theme-specific subset of data objects and thereby identify a respective theme-specific group of one or more construction-related problems that correspond to the respective one of two or more construction-related themes; and
(iv) based at least on the theme-specific groups of one or more construction-related problems that respectively correspond to the two or more construction-related themes, generate a project-specific themes dataset for the respective construction project; and
after generating the project-specific themes datasets for the pool of construction projects:
(i) receive information about a given construction project;
(ii) based at least on the received information about the given construction project, identify, from the pool of construction projects, a given set of construction projects having a threshold level of similarity to the given construction project;
(iii) for each respective construction project in the given set of construction projects, obtain the project-specific themes dataset for the respective construction project;
(iv) based on the project-specific themes datasets that are obtained for the given set of construction projects, determine one or more insights related to the given construction project; and
(v) transmit, to a client station, data defining the one or more insights and thereby cause an indication of the one or more insights to be presented at a user interface of the client station.

2. The computing platform of claim 1, wherein the set of data objects related to the respective construction project comprises a plurality of types of data objects, wherein each type of data object comprise a given set of data fields that differs from the sets of data fields of other types of data objects.

3. The computing platform of claim 1, wherein the program instructions that are executable by the at least one processor such that the computing platform is configured to evaluate the obtained set of data objects related to the respective construction project and thereby identify two or more theme-specific subsets of data objects comprise program instructions that are executable by the at least one processor such that the computing platform is configured to:
for each data object of the obtained set of data objects related to the respective construction project, use one or more machine learning models to output, for each respective theme from the two or more construction-related themes, a predicted likelihood that the data object corresponds to the respective theme; and
based on the predicted likelihoods for the obtained set of data objects related to the respective construction project, identify the two or more theme-specific subsets of data objects.

4. The computing platform of claim 1, wherein the program instructions that are executable by the at least one processor such that the computing platform is configured to evaluate the respective theme-specific subset of data objects and thereby identify a respective theme-specific group of one or more construction-related problems that correspond to the respective one of two or more construction-related themes comprise program instructions that are executable by the at least one processor such that the computing platform is configured to:
for each data object of the respective theme-specific subset of data objects, use one or more machine learning models to output, for each respective problem from two or more construction-related problems, a predicted likelihood that the data object corresponds to the respective problem; and
based on the predicted likelihoods for the respective theme-specific subset of data objects, identify the respective theme-specific group of one or more construction-related problems that correspond to the respective one of two or more construction-related themes.

5. The computing platform of claim 1, wherein each of the two or more construction-related themes are from a predefined group of potential construction-related themes.

6. The computing platform of claim 1, wherein each of the one or more construction-related problems are from a predefined group of potential construction-related problems.

7. The computing platform of claim 1, wherein the program instructions that are executable by the at least one processor such that the computing platform is configured to, based on the project-specific themes datasets that are obtained for the given set of construction projects, determine one or more insights related to the given construction project comprise program instructions that are executable by the at least one processor such that the computing platform is configured to:
for each respective one of the one or more construction-related problems, aggregate themes data from the project-specific themes datasets that are obtained for the given set of construction projects to determine respective problem-specific aggregated themes data for the given set of construction projects; and
based on the respective problem-specific aggregated themes data for the given set of construction projects, determine the one or more insights related to the given construction project.

8. The computing platform of claim 1, further comprising program instructions stored on the non-transitory computer-readable medium that are executable by the at least one processor such that the computing platform is configured to:
based on the project-specific themes dataset for pool of construction projects, generate one or more predefined insights about construction projects; and
transmit, to a second client station, data defining the one or more predefined insights and thereby cause an indication of the one or more predefined insights to be presented at a user interface of the second client station.

9. The computing platform of claim 1, further comprising program instructions stored on the non-transitory computer-readable medium that are executable by the at least one processor such that the computing platform is configured to:
for each problem of a respective theme-specific group of one or more construction-related problems, evaluate data objects corresponding to the theme of the respective theme-specific group and thereby identify one or more underlying reasons as to why the theme is leading to the problem.

10. The computing platform of claim 1, wherein the program instructions are further executable by the at least one processor such that the computing platform is configured to:
prior to, for each respective one of the two or more construction-related themes, evaluating the respective theme-specific subset of data objects and thereby identify a respective theme-specific group of one or more construction-related problems that correspond to the respective one of two or more construction-related themes:
(i) obtain a set of data objects related to a second pool of construction projects;
(ii) evaluate the obtained set of data objects related to the second pool of construction projects and thereby identify two or more theme-specific subsets of data objects for the second pool of construction projects, wherein each respective theme-specific subset of data objects for the second pool of construction projects corresponds to a respective one of two or more construction-related themes for the second pool of construction projects;
(iii) for each respective theme-specific subsets of data objects for the second pool of construction projects, evaluate the respective theme-specific subset of data objects for the second pool of construction projects to identify a respective set of one or more problems corresponding to the respective one of two or more construction-related themes for the second pool of construction projects; and
(iv) based on the respective sets of one or more problems corresponding to the respective one of two or more construction-related themes for the second pool of construction projects, identifying a problem space of construction-related problems; and
wherein each respective one of one or more construction-related problems is a respective construction-related problem of the problem space of construction-related problems.

11. A non-transitory computer-readable medium, wherein the non-transitory computer-readable medium is provisioned with program instructions that, when executed by at least one processor, cause a computing platform to:
for each respective construction project in a pool of construction projects:
(i) obtain a set of data objects related to the respective construction project;
(ii) evaluate the obtained set of data objects related to the respective construction project and thereby identify two or more theme-specific subsets of data objects, wherein each respective theme-specific subset of data objects corresponds to a respective one of two or more construction-related themes;
(iii) for each respective one of the two or more construction-related themes, evaluate the respective theme-specific subset of data objects and thereby identify a respective theme-specific group of one or more construction-related problems that correspond to the respective one of two or more construction-related themes; and
(iv) based at least on the theme-specific groups of one or more construction-related problems that respectively correspond to the two or more construction-related themes, generate a project-specific themes dataset for the respective construction project; and
after generating the project-specific themes datasets for the pool of construction projects:
(i) receive information about a given construction project;
(ii) based at least on the received information about the given construction project, identify, from the pool of construction projects, a given set of construction projects having a threshold level of similarity to the given construction project;
(iii) for each respective construction project in the given set of construction projects, obtain the project-specific themes dataset for the respective construction project;
(iv) based on the project-specific themes datasets that are obtained for the given set of construction projects, determine one or more insights related to the given construction project; and
(v) transmit, to a client station, data defining the one or more insights and thereby cause an indication of the one or more insights to be presented at a user interface of the client station.

12. The non-transitory computer-readable medium of claim 11, wherein the program instructions that, when executed by the at least one processor, cause the computing platform to evaluate the obtained set of data objects related to the respective construction project and thereby identify two or more theme-specific subsets of data objects comprise program instructions that, when executed by at least one processor, cause a computing platform to:
for each data object of the obtained set of data objects related to the respective construction project, use one or more machine learning models to output, for each respective theme from the two or more construction-related themes, a predicted likelihood that the data object corresponds to the respective theme; and
based on the predicted likelihoods for the obtained set of data objects related to the respective construction project, identify the two or more theme-specific subsets of data objects.

13. The non-transitory computer-readable medium of claim 11, wherein the program instructions that, when executed by the at least one processor, cause the computing platform to evaluate the respective theme-specific subset of data objects and thereby identify a respective theme-specific group of one or more construction-related problems that correspond to the respective one of two or more construction-related themes comprise program instructions that, when executed by the at least one processor, cause the computing platform to:
for each data object of the respective theme-specific subset of data objects, use one or more machine learning models to output, for each respective problem from two or more construction-related problems, a predicted likelihood that the data object corresponds to the respective problem; and
based on the predicted likelihoods for the respective theme-specific subset of data objects, identify the respective theme-specific group of one or more construction-related problems that correspond to the respective one of two or more construction-related themes.

14. The non-transitory computer-readable medium of claim 11, wherein the program instructions that, when executed by the at least one processor, cause the computing platform to, based on the project-specific themes datasets that are obtained for the given set of construction projects, determine one or more insights related to the given construction project comprise program instructions that, when executed by the at least one processor, cause the computing platform to:
for each respective one of the one or more construction-related problems, aggregate themes data from the project-specific themes datasets that are obtained for the given set of construction projects to determine respective problem-specific aggregated themes data for the given set of construction projects; and
based on the respective problem-specific aggregated themes data for the given set of construction projects, determine the one or more insights related to the given construction project.

15. The non-transitory computer-readable medium of claim 11, further comprising program instructions that, when executed by the at least one processor, cause the computing platform to:
for each problem of a respective theme-specific group of one or more construction-related problems, evaluate data objects corresponding to the theme of the respective theme-specific group and thereby identify one or more underlying reasons as to why the theme is leading to the problem.

16. A method carried out by a computing platform, the method comprising:
for each respective construction project in a pool of construction projects:
(i) obtaining a set of data objects related to the respective construction project;
(ii) evaluating the obtained set of data objects related to the respective construction project and thereby identifying two or more theme-specific subsets of data objects, wherein each respective theme-specific subset of data objects corresponds to a respective one of two or more construction-related themes;
(iii) for each respective one of the two or more construction-related themes, evaluating the respective theme-specific subset of data objects and thereby identifying a respective theme-specific group of one or more construction-related problems that correspond to the respective one of two or more construction-related themes; and
(iv) based at least on the theme-specific groups of one or more construction-related problems that respectively correspond to the two or more construction-related themes, generating a project-specific themes dataset for the respective construction project; and
after generating the project-specific themes datasets for the pool of construction projects:
(i) receiving information about a given construction project;
(ii) based at least on the received information about the given construction project, identifying, from the pool of construction projects, a given set of construction projects having a threshold level of similarity to the given construction project;
(iii) for each respective construction project in the given set of construction projects, obtaining the project-specific themes dataset for the respective construction project;
(iv) based on the project-specific themes datasets that are obtained for the given set of construction projects, determining one or more insights related to the given construction project; and
(v) transmitting, to a client station, data defining the one or more insights and thereby causing an indication of the one or more insights to be presented at a user interface of the client station.

17. The method of claim 16, wherein evaluating the obtained set of data objects related to the respective construction project and thereby identifying two or more theme-specific subsets of data objects comprises:
for each data object of the obtained set of data objects related to the respective construction project, using one or more machine learning models to output, for each respective theme from the two or more construction-related themes, a predicted likelihood that the data object corresponds to the respective theme; and
based on the predicted likelihoods for the obtained set of data objects related to the respective construction project, identifying the two or more theme-specific subsets of data objects.

18. The method of claim 16, wherein evaluating the respective theme-specific subset of data objects and thereby identifying a respective theme-specific group of one or more construction-related problems that correspond to the respective one of two or more construction-related themes comprises:
for each data object of the respective theme-specific subset of data objects, using one or more machine learning models to output, for each respective problem from two or more construction-related problems, a predicted likelihood that the data object corresponds to the respective problem; and
based on the predicted likelihoods for the respective theme-specific subset of data objects, identifying the respective theme-specific group of one or more construction-related problems that correspond to the respective one of two or more construction-related themes.

19. The method of claim 16, wherein, based on the project-specific themes datasets that are obtained for the given set of construction projects, determining one or more insights related to the given construction project comprises:
for each respective one of the one or more construction-related problems, aggregating themes data from the project-specific themes datasets that are obtained for the given set of construction projects to determine respective problem-specific aggregated themes data for the given set of construction projects; and
based on the respective problem-specific aggregated themes data for the given set of construction projects, determining the one or more insights related to the given construction project.

20. The method of claim 16, further comprising:
for each problem of a respective theme-specific group of one or more construction-related problems, evaluating data objects corresponding to the theme of the respective theme-specific group and thereby identifying one or more underlying reasons as to why the theme is leading to the problem.
